(19) United States
(12) Patent Application Publication
(10) Pub. No.: US 2026/0289466 A1
(43) Pub. Date: Sep. 24, 2026

(54) GENERATION OF VALUE TREES FOR BUSINESSES USING LANGUAGE MODELS

(71) Applicant: International Business Machines Corporation, Armonk, NY (US)

(72) Inventor: Mohamed Elrefai, Danville, CA (US)

(21) Appl. No.: 19/082,238

(22) Filed: Mar. 18, 2025

(51) Int. Cl. G06Q 10/0637

(52) U.S. Cl. CPC G06Q 10/0637

(57) ABSTRACT

Generation of values trees for business includes a determination of a set of value pools, a set of value drivers, and a set of value levers based on an application of a set of language models on first input data and a second input data. The first input data includes at least a count of a set of strategic initiatives, a domain of the business, and a focus area. The second input data includes a count of a set of value pools, a count of a set of value drivers, and a count of a set of value levers. A value tree is generated that includes a set of nodes associated with the at least one strategic initiative of the set of strategic initiatives, the determined set of value pools, the determined set of value drivers, and the determined set of value levers.

### BACKGROUND

The disclosure relates generally to the field of data processing and, more particularly, to value trees.

With the increase in consumer demand and resource availability, the number of businesses associated with various industries (such as the retail industry, the manufacturing industry, the technology industry, and the financial industry) has increased. The increased consumer demand and resource availability lead to the collection and generation of large volumes of data associated with the business operations of the business entities. Examples of business operations include manufacturing operations, sales operations, logistic operations, financial operations, and the like. Additionally, the businesses may analyze the large volume of data to determine business plans associated with a set of business goals. However, the management of the large volume of data and the analysis of the large volume of data is challenging. For example, manual processing of a large volume of data is time-consuming and labor-intensive. Additionally, the manual processing of a large volume of data may lead to human errors (such as a misinterpretation of the large volume of data), thereby reducing the accuracy of the business plans determined based on the manual processing of the large volume of data.

### SUMMARY

In an embodiment of the disclosure, a computer-implemented method for the generation of value trees for businesses using language models is provided. The computer-implemented method further includes receiving, by a computer, first input data including at least a count of a set of strategic initiatives associated with a business, a domain of the business, and a focus area associated with the set of strategic initiatives. The computer-implemented further includes receiving, by the computer, second input data including a count of a set of value pools associated with at least one strategic initiative of the set of strategic initiatives, a count of a set of value drivers associated with the set of value pools, and a count of a set of value levers associated with the set of value drivers. The computer-implemented further includes applying, by the computer, a set of language models on the first input data and the second input data. The computer-implemented further includes determining, by the computer, the set of value pools, the set of value drivers, and the set of value levers based on the application of the set of language models on the first input data and the second input data. The computer-implemented further includes generating, by the computer, a value tree including a set of nodes associated with the at least one strategic initiative of the set of strategic initiatives, the determined set of value pools, the determined set of value drivers, and the determined set of value levers. The value tree is associated with the at least one strategic initiative. The computer-implemented further includes controlling, by the computer, a set of operations associated with an implementation of the at least one strategic initiative of the set of strategic initiatives. The set of operations is controlled based on the generated value tree.

In various embodiments of the disclosure, a computer system and a computer program product for generation of value trees for businesses using language models are provided.

Additional technical features and benefits are realized through the techniques of the disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The following description will provide details of preferred embodiments with reference to the following figures wherein:

FIG. 1 is a diagram that illustrates a computing environment for the generation of value trees for businesses using language models, in accordance with an embodiment of the disclosure;

FIG. 2 is a diagram that illustrates an environment for the generation of value trees for businesses using language models, in accordance with an embodiment of the disclosure;

FIG. 3A, FIG. 3B, and FIG. 3C collectively is a diagram that illustrates exemplary operations for the generation of value trees for businesses using language models, in accordance with an embodiment of the disclosure.

FIG. 4A is a diagram that illustrates an exemplary first user interface for the reception of first input data, in accordance with an embodiment of the disclosure;

FIG. 4B is a diagram that illustrates an exemplary second user interface for the selection of at least one of a determined set of strategic initiatives, in accordance with an embodiment of the disclosure;

FIG. 4C is a diagram that illustrates an exemplary third user interface for the reception of second input data, in accordance with an embodiment of the disclosure;

FIG. 4D is a diagram that illustrates an exemplary fourth user interface for rendering a value tree, in accordance with an embodiment of the disclosure; and

FIG. 5 is a diagram that illustrates a flowchart of a method for the generation of value trees for businesses using language models, in accordance with an embodiment of the disclosure.

### DETAILED DESCRIPTION

With the increase in consumer demand and resource availability, the number of businesses associated with various industries (such as the retail industry, the manufacturing industry, the technology industry, and the financial industry) has increased. The increased consumer demand and resource availability lead to the collection and generation of large volumes of data associated with the business operations of the business entities. Examples of business operations include manufacturing operations, sales operations, logistic operations, financial operations, and the like. Additionally, the businesses may analyze the large volume of data to determine business plans associated with a set of business goals. However, with the management of the large volume of data and the analysis of the large volume of data. For example, manual processing of a large volume of data is time-consuming and labor-intensive. Additionally, the manual processing of a large volume of data may be prone to human errors (such as a misinterpretation of the large volume of data), thereby reducing the accuracy of the business plans determined based on the manual processing of the large volume of data.

Hence, mitigating the aforementioned challenges associated with the manual processing of a large volume of data is time-consuming, and there is a need for automation of the manual processing of the large volume of data associated with the business operations of the business entities. In an embodiment of the disclosure, the computer system may generate a value tree for the automation of the manual processing of a large volume of data. In an embodiment of the disclosure, the computer system may receive first input data that includes at least a count associated with the set of strategic initiatives, a domain of a business, and a focus area associated with the set of strategic initiatives. Each strategic initiative of the set of strategic initiatives corresponds to a high-priority vision aimed at driving a business value and a business transformation. The set of strategic initiatives includes a cross-functional collaboration to develop innovative solutions that address challenges associated with the set of strategic initiatives or opportunities associated with the set of strategic initiatives. The set of strategic initiatives further includes an iterative approach for focus on data-driven decision-making and tangible outcomes aligned with the set of strategic initiatives.

For example, the business is an insurance company, the count of the set of strategic initiatives is 3, the domain of the business is insurance, and a focus area associated with the set of strategic initiatives is reduced issues from claim fraud. In an embodiment of the disclosure, the computer system is configured to receive the first input data from a user (such as a business executive) associated with the business. The reception of the first input data allows the computer system to generate the value tree associated with the set of strategic initiatives. In an embodiment of the disclosure, the computer system is configured to receive the first input data via a user interface associated with the computer system. In various embodiments of the disclosure, the computer system is configured to render one or more user interface (UI) elements. Further, the computer system is configured to receive the first input data on the one or more UI elements. Additionally, the reception of the first input data on the one or more UI elements decreases the likelihood of missing some portion of the first input data in a manual collection of the first input data.

Further, the computer system may receive second input data that includes a count (such as 1, 2, or 4) of a set of value pools associated with at least one strategic initiative of the set of strategic initiatives, a count (such as 3, 4, or 5) of a set of value drivers associated with the set of value pools, and a count (such as 2, 4, or 6) of a set of value levers associated with the set of value drivers. Each value pool of the set of value pools is indicative of a business segment associated with the business. The business segment represents at least one opportunity for a generation of revenue for the business or the creation of value for the business. Further, the performance of each value pool of the set of value pools and the profitability of each value pool of the set of value pools are based on the set of value drivers. For example, a first opportunity for the generation of revenue for the business is an operational efficiency and cost and the creation of a first value of the business with respect to the first opportunity is $200000.

The set of value drivers includes a set of objectives with respect to the at least one opportunity for the generation of revenue for the business. Additionally, the set of value drivers includes a set of objective values associated with the set of objectives. Each objective value of the set of objective values is indicative of a potential value with respect to an implementation of the corresponding objective of the set of objectives. For example, a first objective of the set of objectives corresponds to an efficient fraud detection and a first objective value is $10000 with respect to the first objective.

Moreover, each value pool of the set of value pools is based on each value lever of the set of value levers. The set of value levers includes a set of actions with respect to the at least one objective of the set of objectives. Additionally, the set of value levers includes a set of results associated with an implementation of at least one action of the set of actions. Further, the set of value levers includes a set of action values that is indicative of an estimated revenue that will be generated with an implementation of the corresponding action of the set of actions. For example, the first action of the set of actions corresponds to a machine learning model application with respect to the first objective (efficient fraud detection), and a first result corresponds to increased accuracy of fraud detection with the implementation of the first action (the machine learning models application), and a first action value corresponds to $10000 for the implementation of the first action.

Moreover, the computer system may apply the set of language models on the first input and the second input data. Further, the computer system may determine the set of value pools, the set of value drivers, and the set of value levers based on the application of the set of language models on the first input data and the second input data. The utilization of the set of language models for determining the set of value pools, the set of value drivers, and the set of value levers is advantageous as compared to traditional methods. Specifically, the traditional methods require extensive manual effort and time for the determination of an association between the first data and the second input data. However, the set of language models may analyze patterns in the first input data and the second input data based on historical business data (such as a historical set of strategic initiatives, a historical set of challenges associated with the historical set of strategic initiatives, a historical set of solutions for the historical set of challenges) associated with a plurality of businesses.

In an embodiment of the disclosure, the utilization of the set of language models allows the computer system to generate the value tree including a set of nodes associated with at least the set of strategic initiatives. The set of nodes includes at least a first subset of nodes associated with at least one strategic initiative, a second subset of nodes associated with the set of value pools, a third subset of nodes associated with the set of value drivers, and a fourth subset of nodes associated with the set of value levers and the set of key levers.

The utilization of the set of language models allows the computer system to increase the accuracy of the generated value by eliminating manual evaluation. By utilizing the set of language models, the computer system may be utilized in any domain where the generation of the value tree is vital for decision making. Further, the computer system provides a way for the business to adopt the set of language models in domain-specific environments with greater confidence and leverage automation to improve efficiency, reduce operational risks, and optimize decision-making based on the generation of the value tree by the set of language models.

The computer system further reduces the overall processing time to generate the value tree by the set of language models, thereby eliminating the need for the generation of the value tree with the manual expertise and the analysis of the manual expertise. The computer system further eliminates the need for presence of the domain-specific experts associated with the business to generate the value tree. Specifically, the generation of the value tree based on the application of the set of language models allows the computer system to decrease human errors (such as the subjectivity for the decision-making) associated with a manual generation of the value tree. Additionally, the generation of the value tree based on the application of the set of language models allows the computer system to render the set of nodes in a hierarchical structure, thereby ensuring systematic decision-making based on the set of nodes. Moreover, the computer system may iteratively utilize the generated value tree for the decision-making. Additionally, the computer system may dynamically update the generated value tree based on the updating of at least one node of the set of nodes. The dynamic updating of the generated value tree allows the computer system to dynamically determine challenges (such as false positives for the claim frauds) associated with an implementation of the at least one strategic initiative (such as the reduction of the issues from the claim frauds) and solutions (such as an application of risk-based scoring rules on insurance applications) of the challenges associated with the implementation of the at least one strategic initiative. Further, the dynamically determined solutions are automatically executed by the disclosed system that overcomes the requirements of manual intervention that is actively done in the traditional methods. Furthermore, the dynamic execution of the solutions also overcomes the problem of vulnerability in the existing solutions (if present), thereby improving the overall security of the system or a remote system (if the solutions are executed on the remote system).

In an embodiment of the disclosure, the computer system may automatically control the set of operations associated with the implementation of at least one strategic initiative of the set of strategic initiatives. The set of operations is controlled based on the generated value tree. The set of operations includes a strategic initiative data collection operation, a strategic initiative planning operation, a strategic initiative communication operation, a strategic initiative report generation operation, and a strategic initiative visualization operation.

In the strategic initiative data collection operation, the computer system is configured to collect strategic initiative data associated with the at least one strategic initiative from one or more sources (such as a database, a website, and the like). The one or more sources are associated with the at least one strategic initiative. The strategic initiative data includes a set of goals (such as revenue growth, market innovation, product innovation, and the like) associated with at least one strategic initiative. Further, the strategic initiative data includes a set of key performance indicators (such as a revenue growth percentage, a customer retention rate, an operational cost, and the like) that are indicative of the success of at least one strategic initiative, and a duration (such as 10 days, 1 month, 3 months, 6 months, 1 year, 5 years and the like) for a completion of the at least one strategic initiative.

In the strategic initiative planning operation, the computer system is configured to determine a set of plans to complete the at least one strategic initiative. In an embodiment of the disclosure, the computer system is configured to determine the set of plans based on an application of the set of language models on the strategic initiative data. The set of plans includes a priority value (such as 1, 3, 5, and 10) of one or more tasks associated with the at least one strategic initiative, a set of resources (such as a number of workers, an identifier of computational resources (such as computers, cloud storage spaces, and the like)) for the completion of the at least one strategic initiative.

In the strategic initiative communication operation, the computer system is configured to establish a communication between each entity of a set of entities (such as a set of workers, a set of users, and a set of devices) associated with the at least one strategic initiative. In the strategic initiative report generation operation, the computer system is configured to generate a set of reports associated with the at least one strategic initiative. The set of reports includes, but is not limited to, a monthly goal report for the at least one strategic initiative, a quarterly goal report for the at least one strategic initiative, and a yearly goal report for the at least one strategic initiative. In the strategic initiative visualization operation, the computer system is configured to visualization data associated with the at least one strategic initiative. For example, the visualization data corresponds to a set of tables, a set of pie graphs, a set of bar graphs, a set of line graphs, and the like. The visualization data is indicative of a status (such as a complete status, an incomplete status, or a not-picked status) for each task of the one or more tasks, the performance of each worker of the set of workers, and the like. In an embodiment of the disclosure, the computer system is configured to output the value tree based on the generation of the value tree. In an embodiment of the disclosure, the computer system is configured to output the value tree on the user interface associated with the computer system. In various embodiments of the disclosure, the computer system is configured to output the value tree on a display screen of a user device.

In an embodiment of the disclosure, a computer-implemented method for generation of value trees for businesses using language models is provided. The computer-implemented method further includes receiving, by a computer, first input data including at least a count of a set of strategic initiatives associated with a business, a domain of the business, and a focus area associated with the set of strategic initiatives. The computer-implemented further includes receiving, by the computer, second input data including a count of a set of value pools associated with at least one strategic initiative of the set of strategic initiatives, a count of a set of value drivers associated with the set of value pools, and a count of a set of value levers associated with the set of value drivers. The computer-implemented further includes applying, by the computer, a set of language models on the first input data and the second input data. The computer-implemented further includes determining, by the computer, the set of value pools, the set of value drivers, and the set of value levers based on the application of the set of language models on the first input data and the second input data. The computer-implemented further includes generating, by the computer, a value tree including a set of nodes associated with the at least one strategic initiative of the set of strategic initiatives, the determined set of value pools, the determined set of value drivers, and the determined set of value levers. The value tree is associated with the at least one strategic initiative. The computer-implemented further includes controlling, by the computer, a set of operations associated with an implementation of the at least one strategic initiative of the set of strategic initiatives. The set of operations is controlled based on the generated value tree.

In various embodiments of the disclosure, each value pool of the set of value pools is indicative of a business segment associated with the business. The business segment represents at least one opportunity for generation of revenue for the business or a creation of a value of the business.

In various embodiments of the disclosure, a performance of each value pool of the set of value pools and a profitability of each value pool of the set of value pools are based on the set of value drivers.

In various embodiments of the disclosure, each value pool of the set of value pools is based on each value lever of the set of value levers.

In various embodiments of the disclosure, the computer-implemented method further includes applying, by the computer, the set of language models on the first input data. The computer-implemented method includes determining, by the computer, the set of strategic initiatives based on the application of the set of language models on the first input data. The computer-implemented method includes receiving, by the computer, a first input associated with a selection of the at least one strategic initiative of the determined set of strategic initiatives. The computer-implemented method further includes selecting, by the computer, the at least one strategic initiative of the determined set of strategic initiatives based on the received first input.

In various embodiments of the disclosure, the second input data includes a count of a set of key levers associated with the set of value levers. The set of nodes is associated with the set of key levers associated with the set of value levers.

In various embodiments of the disclosure, the set of nodes includes at least a first subset of nodes associated with the at least one strategic initiative, a second subset of nodes associated with a set of value pools, a third subset of nodes associated with a set of value drivers, and a fourth subset of nodes associated with the set of value levers and the set of key levers.

In various embodiments of the disclosure, the computer-implemented method further includes receiving, by the computer, third input data including at least a count of a set of pain points associated with the set of value levers. The computer-implemented method further includes applying, by the computer, the set of language models on the first input data, the second input data, the third input data, and the value tree. The computer-implemented method further includes determining, by the computer, the set of pain points based on the application of the set of language models on the first input data, the second input data, the third input data, and the value tree. The computer-implemented method further includes modifying, by the computer, the value tree based on the determined set of pain points. The modification of the value tree corresponds to an inclusion of a fifth subset of nodes associated with the determined set of pain points. The set of nodes includes the fifth subset of nodes. The computer-implemented method further includes outputting, by the computer, the modified value tree.

In various embodiments of the disclosure, each pain point of the set of pain points corresponds to a challenge associated with an implementation of a corresponding value lever of the set of value levers.

In various embodiments of the disclosure, the computer-implemented method further includes receiving, by the computer, fourth input data including at least a count of a set of program epics associated with at least one lever of the set of value levers. The computer-implemented method further includes applying, by the computer, the set of language models on the first input data, the second input data, the third input data, the fourth input data, and the value tree. The computer-implemented method further includes determining, by the computer, the set of program epics based on the application of the set of language models on the first input data, the second input data, the third input data, the fourth input data, and the value tree. The computer-implemented method further includes modifying, by the computer, the value tree based on the determined set of program epics. The modification of the value tree corresponds to an inclusion of a sixth subset of nodes associated with the determined set of program epics. The set of nodes includes the sixth subset of nodes. The computer-implemented method further includes outputting, by the computer, the modified value tree.

In various embodiments of the disclosure, each program epic of the set of program epics corresponds to a solution to the challenge associated with the implementation of the corresponding value lever of the set of value levers.

In various embodiments of the disclosure, the computer-implemented method further includes receiving, by the computer, fifth input data including at least a count of a set of features associated with at least one program epic of the set of program epics and a set of data sources of business data associated with the business. The computer-implemented method further includes applying, by the computer, the set of language models on the first input data, the second input data, the third input data, the fourth input data, the fifth input data, and the value tree. The computer-implemented method further includes determining, by the computer, the set of features based on the application of the set of language models on the first input data, the second input data, the third input data, the fourth input data, the fifth input data, and the value tree. The computer-implemented method further includes modifying, by the computer, the value tree based on the determined set of features. The modification of the value tree corresponds to an inclusion of a seventh subset of nodes associated with the set of program epics. The set of nodes includes the seventh subset of nodes. The computer-implemented method further includes outputting, by the computer, the modified value tree.

In various embodiments of the disclosure, each feature of the set of features corresponds to one or more characteristics associated with a corresponding program epic of the set of program epics.

In various embodiments of the disclosure, the computer-implemented method of claim 12, further including receiving, by the computer, sixth input data including at least a count of a set of user stories associated with at least one feature of the set of features. The computer-implemented method further includes applying, by the computer, the set of language models on the first input data, the second input data, the third input data, the fourth input data, the fifth input data, the sixth input data, and the value tree. The computer-implemented method further includes determining, by the computer, the set of user stories based on the application of the set of language models on the first input data, the second input data, the third input data, the fourth input data, the fifth input data, the sixth input data, and the value tree. The computer-implemented method further includes modifying, by the computer, the value tree based on the determined set of user stories. The modification of the value tree corresponds to an inclusion of an eighth subset of nodes associated with the determined set of user stories. The set of nodes includes the sixth subset of nodes includes the eighth subset of nodes. The computer-implemented method further includes outputting, by the computer, the modified value tree.

In various embodiments of the disclosure, each user story of the set of user stories corresponds to one or more tasks associated with an implementation of a corresponding feature of the set of features.

In various embodiments of the disclosure, the computer-implemented method further includes receiving, by the computer, a second input associated with a creation of at least one feature of the set of features. The computer-implemented method further includes applying, by the computer, the set of language models on the first input data, the second input data, the third input data, the fourth input data, the fifth input data, the sixth input data, the second input, and the value tree. The computer-implemented method further includes creating, by the computer, the at least one feature of the set of features based on the application of the set of language models on the first input data, the second input data, the third input data, the fourth input data, the fifth input data, the sixth input data, the second input, and the value tree. The computer-implemented method further includes modifying, by the computer, the value tree based on the creation of the at least one feature. The modification of the value tree corresponds to an inclusion of at least one node in the eighth subset of nodes associated with the set of user stories. The at least one node in the eighth subset is associated with the created at least one feature. The computer-implemented method further includes outputting, by the computer, the modified value tree.

In various embodiments of the disclosure, the first input data includes of first emphasis data, the second input data includes of second emphasis data, the third input data includes of third emphasis data, the fourth input data includes of fourth emphasis data, the fifth input data includes of fifth emphasis data, and the sixth input data includes of sixth emphasis data.

In various embodiments of the disclosure, each language model of the set of language models is pre-trained on historical business data associated with a plurality of businesses.

In various embodiments of the disclosure, a computer system for generation of value trees for businesses using language models is provided. The computer system includes a processor set, one or more computer-readable storage media, and program instructions stored on the one or more computer-readable storage media. The program instructions are executable by the processor set to cause the processor set to receive first input data including at least a count of a set of strategic initiatives associated with a business, a domain of the business, and a focus area associated with the set of strategic initiatives. The program instructions further cause the processor set to receive second input data including a count of a set of value pools associated with at least one strategic initiative of the set of strategic initiatives, a count of a set of value drivers associated with the set of value pools, and a count of a set of value levers associated with the set of value drivers. The program instructions further cause the processor set to apply a set of language models on the first input data and the second input data. The program instructions further cause the processor set to determine the set of value pools, the set of value drivers, and the set of value levers based on the application of the set of language models on the first input data and the second input data. The program instructions further cause the processor set to generate a value tree including a set of nodes associated with the at least one strategic initiative of the set of strategic initiatives, the determined set of value pools, the determined set of value drivers, and the determined set of value levers. The value tree is associated with the at least one strategic initiative. The program instructions further cause the processor set to control a set of operations associated with an implementation of the at least one strategic initiative of the set of strategic initiatives. The set of operations is controlled based on the generated value tree.

In various embodiments of the disclosure, a computer program product for generation of value trees for businesses using language models is provided. The computer program product includes one or more computer-readable storage media. The program instructions are stored on the one or more computer-readable storage media to perform operations. The operations include receiving first input data including at least a count of a set of strategic initiatives associated with the business, a domain of the business, and a focus area associated with the set of strategic initiatives. The operations include receiving second input data including a count of a set of value pools associated with the at least one strategic initiative of the set of strategic initiatives, a count of a set of value drivers associated with the set of value pools, and a count of a set of value levers associated with the set of value drivers. The operations include applying a set of language models on the first input data and the second input data. The operations include determining the set of value pools, the set of value drivers, and the set of value levers based on the application of the set of language models on the first input data and the second input data. The operations include generating the value tree including a set of nodes associated with the at least one strategic initiative of the set of strategic initiatives, the determined set of value pools, the determined set of value drivers, and the determined set of value levers. The value tree is associated with the at least one strategic initiative. The operations include controlling a set of operations associated with an implementation of the at least one strategic initiative of the set of strategic initiatives. The set of operations is controlled based on the generated value tree.

Various aspects of the disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or freely propagating electromagnetic waves, electromagnetic waves propagating through a waveguide, light pulses passing through a fiber optic cable, electrical signals communicated through a wire, and/or transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

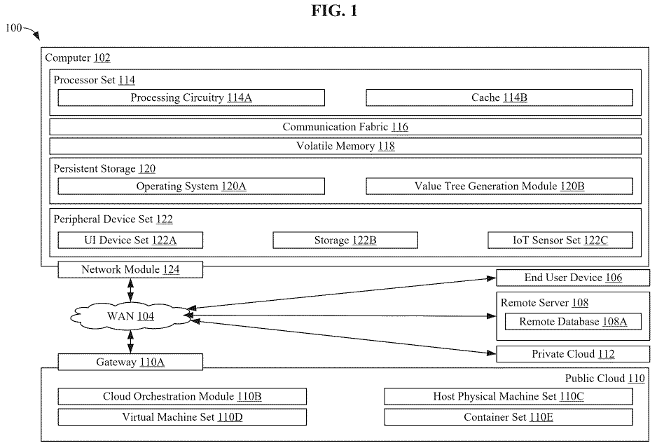

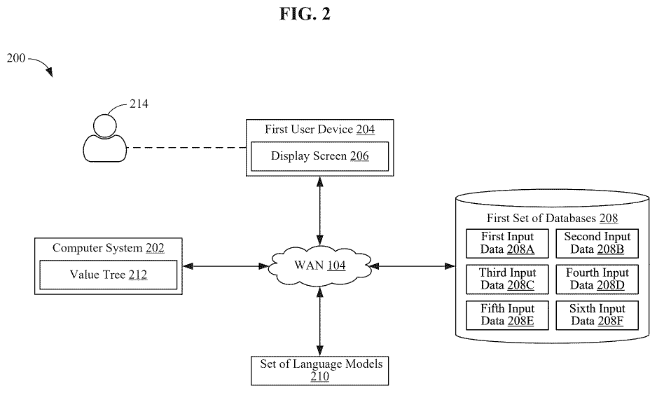

FIG. 1 is a diagram that illustrates a computing environment for the generation of value trees for businesses using language models, in accordance with an embodiment of the disclosure. With reference to FIG. 1, there is shown a computing environment 100 that contains an example of an environment for execution of at least some of the computer code/module involved in performing the methods, such as a value tree generation module 120B. In addition to the value tree generation module 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the value tree generation module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or wearable computer, a mainframe computer, a quantum computer, or any form of a computer or a mobile device now known or to be developed in the future that is capable of running a program, accessing a network or querying a database, such as a remote database 108A. As is well understood in the art of computer technology, and depending upon the technology, the performance of a computer-implemented method may be distributed among multiple computers and/or between multiple locations. Alternatively, in this presentation of the computing environment 100, detailed discussion is focused on a single computer, specifically the computer 102, to keep the presentation as simple as possible. The computer 102 may be located in a cloud, even though it is not shown in a cloud in FIG. 1. Alternatively, the computer 102 is not needed to be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the methods”). These computer-readable program instructions are stored in various types of computer-readable storage media, such as the cache 114B and various storage media discussed below. The program instructions, and associated data, are accessed by the processor set 114 to control and direct the performance of the methods. In computing environment 100, at least some of the instructions for performing the methods may be stored in the dynamic modification of the value tree generation module 120B in persistent storage 120.

The communication fabric 116 is the signal conduction path that allows the various components of computer 102 to communicate among themselves. Typically, this fabric is made of switches and electrically conductive paths, such as the switches and electrically conductive paths that make up buses, bridges, physical input/output ports, and the like. Various types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not needed unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 may be a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the value tree generation module 120B typically includes at least some of the computer code involved in performing the disclosed methods.

The peripheral device set 122 includes the set of peripheral devices of computer 102. Data communication connections between the peripheral devices and the various components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments of the disclosure, storage 122B may take the form of a quantum computing storage device for storing data in the form of qubits. In embodiments of the disclosure where computer 102 is needed to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, a first sensor may be a thermometer, and a second sensor may be a motion detector.

The network module 124 is the collection of computer software, hardware, and firmware that allows computer 102 to communicate with various computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In an embodiment of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by various computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or various computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

FIG. 2 is a diagram that illustrates an environment for the generation of value trees for businesses using language models, in accordance with an embodiment of the disclosure. FIG. 2 is explained in conjunction with elements from FIG. 1. With reference to FIG. 2, there is shown a diagram of a network environment 200. The network environment 200 includes a computer system 202, a first user device 204 that includes a display screen 206, a first set of databases 208, a set of language models 210, and a value tree 212. In an embodiment of the disclosure, the first set of databases 208 is configured to store first input data 208A, second input data 208B, third input data 208C, fourth input data 208D, fifth input data 208E, and sixth input data 208F. With reference to FIG. 2, there is further shown a user 214 associated with the first user device 204. The network environment 200 further includes the WAN 104 of FIG. 1. In an embodiment of the disclosure, the computer system 202 is an exemplary embodiment of the computer 102 in FIG. 1. Similarly, in an embodiment of the disclosure, the first user device 204 is an example embodiment of the EUD 106 of FIG. 1.

The computer system 202 includes suitable logic, circuitry, and/or interfaces for the generation of value trees for businesses using language models. The computer system 202 is configured to receive the first input data 208A including at least a count of a set of strategic initiatives associated with a business, a domain of the business, and a focus area associated with the set of strategic initiatives. The computer system 202 is configured to receive the second input data 208B including a count of a set of value pools associated with at least one strategic initiative of the set of strategic initiatives, a count of a set of value drivers associated with the set of value pools, and a count of a set of value levers associated with the set of value drivers. The computer system 202 is configured to apply the set of language models 210 on the first input data 208A and the second input data 208B. The computer system 202 is further configured to determine the set of value pools, the set of value drivers, and the set of value levers based on the application of the set of language models 210 on the first input data 208A and the second input data 208B. The computer system 202 is further configured to generate the value tree 212 including a set of nodes associated with the at least one strategic initiative of the set of strategic initiatives, the determined set of value pools, the determined set of value drivers, and the determined set of value levers. The value tree 212 is associated with the at least one strategic initiative. The computer system 202 is configured to control a set of operations based on at least one node of the set of nodes.

Examples of the computer system 202 include but are not limited to, a server, a computing device, a virtual computing device, a mainframe machine, a computer workstation, a smartphone, a cellular phone, a mobile phone, a gaming device, or a consumer electronic (CE) device. For example, embodiment of the disclosure, the computer system 202 may be embodied as a cloud-based service, a cloud-based application, a cloud-based platform, a remote server-based service, a remote server-based application, a remote server-based platform, or a virtual computing system.

The first user device 204 may include suitable logic, circuitry, interfaces, and/or code that are configured to transmit the first input data 208A, the second input data 208B, the third input data 208C, the fourth input data 208D, the fifth input data 208E, the sixth input data 208F, the value tree 212 or a combination thereof to the computer system 202. In an embodiment, the first user device 204 may include the display screen 206. In an embodiment of the disclosure, the first user device 204 is further configured to display the first input data 208A, the second input data 208B, the third input data 208C, the fourth input data 208D, the fifth input data 208E, the sixth input data 208F, and the value tree 212 on the display screen 206 associated with the first user device 204. The first user device 204 may be associated with the user 214. In an embodiment of the disclosure, the user 214 may be a person who wishes to generate the value tree 212. In various embodiments of the disclosure, the user 214 corresponds to a set of business entities that want to generate the value tree 212. Examples of the first user device 204 may include, but are not limited to, a computing device, a mainframe machine, a server, a computer work-station, a smartphone, a cellular phone, a mobile phone, a gaming device, a consumer electronic (CE) device, a head-mounted device, a Virtual Reality (VR) Headset, an Augmented Reality (AR) Device, a Mixed Reality (MR) Device, a Projection-based System, and/or any device with computer vision display capabilities.

The display screen 206 may include suitable logic, circuitry, and interfaces that are configured to render the generated value tree 212. In an embodiment of the disclosure, the display screen 206 may be an external display device associated with the first user device 204. The display screen 206 may be a touch screen which may enable the user 214 to provide the first input data 208A, the second input data 208B, the third input data 208C, the fourth input data 208D, the fifth input data 208E, the sixth input data 208F, or any combination thereof. The touch screen may be at least one of a resistive touch screen, a capacitive touch screen, or a thermal touch screen. In accordance with an embodiment of the disclosure, the display screen 206 may refer to a display screen 206 of a head-mounted device (HMD), a smart-glass device, a see-through display, a projection-based display, an electro-chromic display, or a transparent display. In some embodiments of the disclosure, the display screen 206 may be realized through several known technologies such as, but are not limited to, at least one of a Liquid Crystal Display (LCD) display, a Light Emitting Diode (LED) display, a plasma display, or an Organic LED (OLED) display technology, or any display devices.

Each database of the first set of databases 208 may correspond to an organized collection of data that may be stored and accessed electronically from a computer system (such as the computer system 202). In an embodiment, each database of the first set of databases 208 may be designed to manage, store, retrieve, and update the first input data 208A, the second input data 208B, the third input data 208C, the fourth input data 208D, the fifth input data 208E, the sixth input data 208F, or any combination thereof. In an embodiment of the disclosure, the first set of databases 208 may store historical business data associated with a plurality of businesses. The historical business data includes, but is not limited to, a historical set of strategic initiatives, a historical set of challenges associated with the historical set of strategic initiatives, and a historical set of solutions associated with the historical set of challenges. The structure of each database of the first set of databases 208 typically involves tables, records, and fields that can be managed through various database management systems (DBMS). Examples of each database of the first set of databases 208 may include, but are not limited to, a relational database, a Non-Structured Query Language (SQL) database, a hierarchical database, a network database, a transactional database, a data warehouse, and a distributed database.

Each language model of the set of language models 210 may be a sophisticated piece of software that leverages natural language processing (NLP) and machine learning techniques to understand, generate, and manipulate human language. Each language model of the set of language models 210 may correspond to a large language model (LLM) model that is specifically designed for tasks related to language understanding and generation on a large scale. Certain characteristics of the LLM model may include, but are not limited to, natural language understanding, text generation, semantic understanding, transfer learning, multimodal capabilities, continuous learning, and user interaction. For example, the LLM model for language processing may be implemented using GPT, Bidirectional Encoder Representations from Transformers (BERT), and the like.

Further, the LLM may be a type of ML model specifically designed to understand, generate, and manipulate human language on a large scale. LLMs may leverage machine learning techniques, particularly those based on deep learning architectures, to process and comprehend natural language. LLMs have gained prominence for their ability to perform a wide range of language-related tasks, including natural language understanding, text generation, translation, summarization, and more. Typically, LLMs may be characterized by a vast number of parameters, often ranging from tens of millions to billions. The large parameter count allows these models to capture complex language patterns and relationships during training.

For example, the LLMs may be considered to be built on Transformer architecture, however, this should not be construed as a limitation. For example, the transformer architecture effectively captures long-range dependencies and contextual information in language. Moreover, the transformer architecture may use attention mechanisms to weigh the significance of different parts of an input sequence. In addition, the LLMs may employ bidirectional processing, allowing the models to consider context from both directions when analyzing a sequence of words. This bidirectional approach enhances the model's understanding of the context in which words appear. For example, the LLMs may generate contextual representations of words, meaning that the representation of a word is influenced by its surrounding context. This enables the model to capture the meaning of words in different contexts.

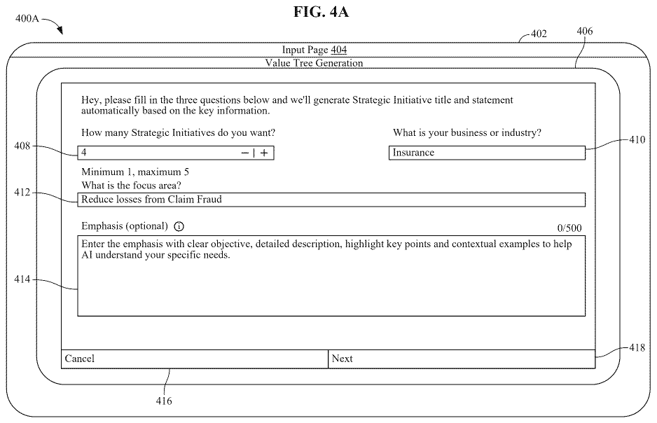

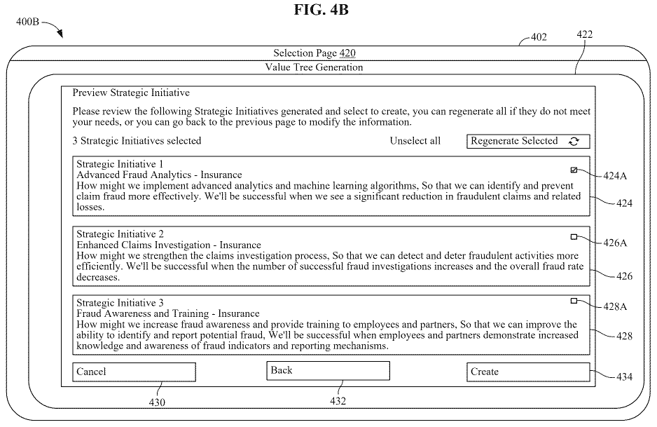

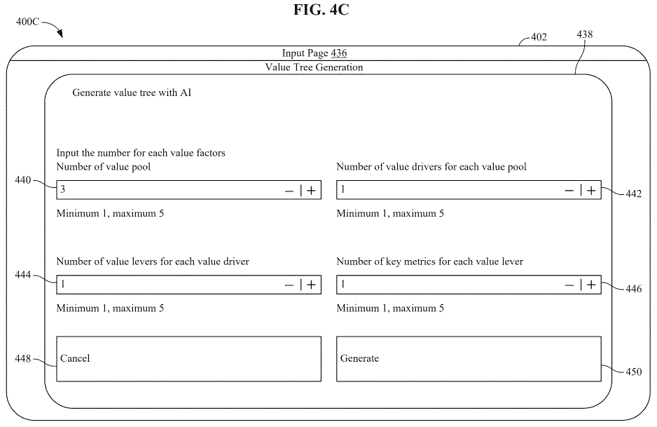

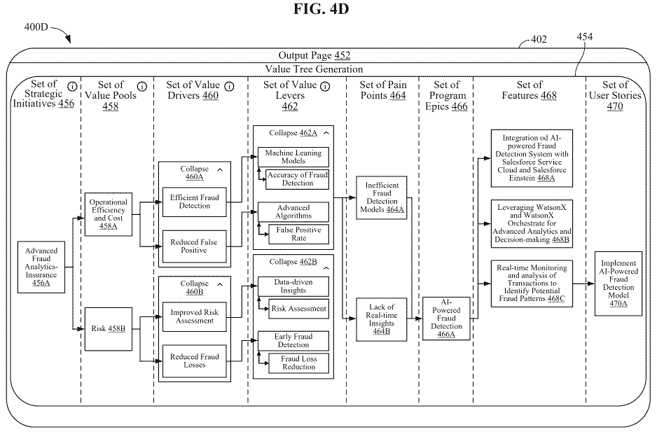

Recently, the use of LLMs has increased manifold for a variety of language-related tasks, such as sentiment analysis, text classification, question answering, machine translation, summarization, and conversational agents. Due to a large number of parameters, training of LLMs from scratch is a time-consuming and expensive process, and therefore, not preferable. To address this problem, pre-trained LLMs are used for generic tasks. For example, LLMs are typically pre-trained on extensive and diverse datasets containing a wide variety of text from the internet. Pre-training involves exposing the model to a broad range of language patterns, allowing it to learn general linguistic features. However, for performing domain-specific tasks, adaptation of LLMs for the particular domain needs to be performed. In one example, LLMs may leverage transfer learning where the model is pre-trained on a large corpus of data and then fine-tuned for specific tasks or domains. This approach enables the model to transfer the knowledge gained during pre-training to various downstream applications. For example, each LLM is pre-trained on the historical business data associated with the plurality of businesses (such as a retail business, a manufacturing business, a technology business, a financial business, and the like). Details about the implementation of the set of language models 210 for the determination of the at least one of the set of nodes are provided, for example, in FIG. 4A, FIG. 4B, and FIG. 4C.

It may be noted that a base model in an LLM refers to a trained model that has been trained on a large corpus of data for a general natural language understanding and generation task. The trained model serves as a foundation for capturing broad linguistic patterns and knowledge from diverse sources. For example, in the context of pre-trained transformers, a base model is pre-trained on a massive dataset to predict the next word in a sequence, effectively learning grammar, context, and semantics from diverse language patterns.

For example, the base model contains a large number of parameters and exhibits a high level of language understanding, making it a powerful starting point for a variety of natural language processing tasks. While the base model is pre-trained on a large corpus of general language data, fine-tuning or adapting the base model for specific tasks or domains enhances its performance and makes it more suitable for targeted applications.

Continuing further, an adapter refers to a smaller and task-specific module added to the base model to adapt the base model for a particular task or domain. The adapter includes a lightweight set of parameters that is trained on task-specific data while keeping all or the majority of the base model's parameters frozen. In particular, the adapter is used to fine-tune the base model for a specific downstream task without extensively modifying its pre-trained parameters. This approach is beneficial when computational resources or labeled task-specific data are limited.

Examples of the first language model of the set of language models 210 include one of but are not limited to, an artificial neural network (ANN), a deep neural network (DNN), a convolutional neural network (CNN), a fully connected neural network, and/or a combination of such networks.

In operation, the computer system 202 is configured to receive the first input data 208A including at least the count of the set of strategic initiatives associated with the business, the domain of the business, and the focus area associated with the set of strategic initiatives. In an embodiment of the disclosure, the computer system 202 is configured to receive the first input data 208A from the user 214. The computer system 202 is configured to receive the second input data 208B including the count of the set of value pools associated with the at least one strategic initiative of the set of strategic initiatives, the count of a set of value drivers associated with the set of value pools, and the count of the set of value levers associated with the set of value drivers. Each value pool of the set of value pools is indicative of a business segment associated with the business. The business segment represents at least one opportunity for the generation of revenue for the business or the creation of value for the business. Further, the performance of each value pool of the set of value pools and the profitability of each value pool of the set of value pools are based on the set of value drivers. Additionally, each value pool of the set of value pools is based on each value lever of the set of value levers. Details about the reception of the first input data 208A and the second input data 208B are provided, for example, in FIG. 4A.

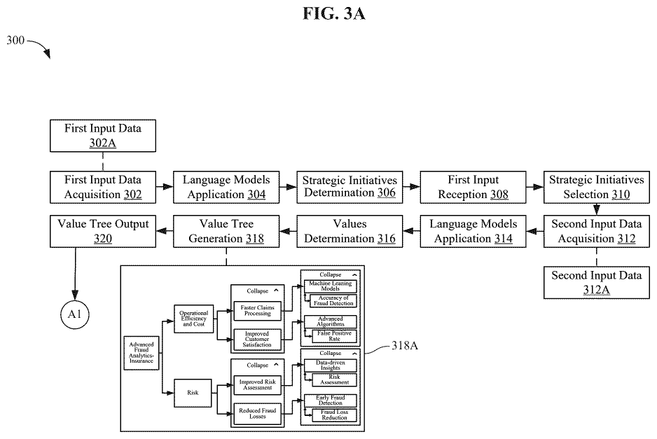

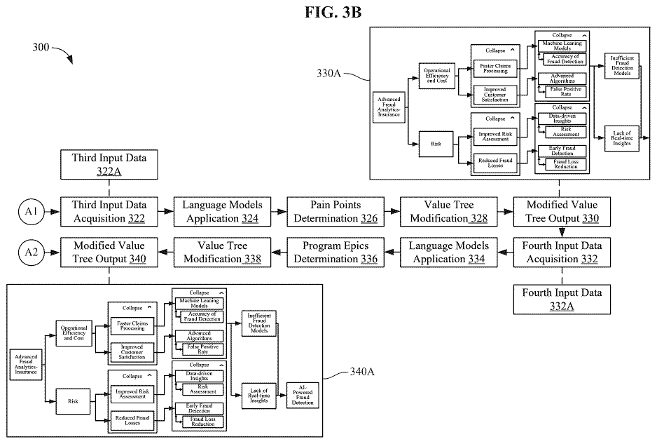

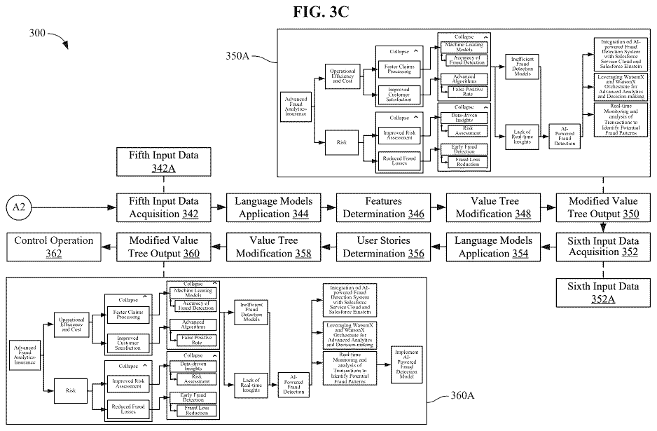

The computer system 202 is configured to apply the set of language models 210 on the first input data 208A and the second input data 208B. In an embodiment of the disclosure, the computer system 202 is configured to provide the first input data 208A and the second input data 208B, as an input, to the set of language models 210. Details about the application of the set of language models 210 on the first input data 208A and the second input data 208B are provided, for example, in FIG. 3A, FIG. 3B, and FIG. 3C.

The computer system 202 is configured to determine the set of value pools, the set of value drivers, and the set of value levers based on the application of the set of language models 210 on the first input data 208A and the second input data 208B. Details about the determination of the set of value pools, the set of value drivers, and the set of value levers based on the application of the set of language models 210 are provided, for example, in FIG. 3A, FIG. 3B, and FIG. 3C.

The computer system 202 is configured to generate the value tree 212 including the set of nodes associated with the at least one strategic initiative of the set of strategic initiatives, the determined set of value pools, the determined set of value drivers, and the determined set of value levers. The value tree 212 is associated with the at least one strategic initiative. The value tree 212 corresponds to a hierarchal structure that decomposes the at least one strategic initiative into a set of nodes. The set of nodes includes at least a first subset of nodes associated with the at least one strategic initiative, a second subset of nodes associated with the set of value pools, a third subset of nodes associated with the set of value drivers, and a fourth subset of nodes associated with the set of value levers and the set of key levers. Further, the first subset of nodes, the second subset of nodes, the third subset of nodes, and the fourth subset of nodes are associated with a respective layer of the value tree 212. Further, each successive layer of the value tree 212 from the first subset of nodes is generated to align the set of nodes (the second subset of nodes, the third subset of nodes, the fourth subset of nodes, and the like) with respect to the first subset of nodes. The decomposition of the at least one strategic initiative into the set of nodes allows the user 214 to analyze a predicted profit from an implementation of the at least one strategic initiative, one or more techniques to implement the at least one strategic initiative, a priority of one or more tasks associated with the at least one strategic initiative, and the like. By way of example, and not by limitation, the value tree 212 includes the first subset of nodes indicative of the at least one strategic initiative (Advanced Fraud Analytics-Insurance), the second subset of nodes indicative of the focus area (Operational Efficiency and Cost) and a predicted revenue ($100000) by implementing the at least one strategic initiative, the third subset of nodes (Efficiency Fraud Detection) to implement the second subset of nodes, and the fourth subset of nodes (Machine Leaning Models) to implement the third subset of nodes. Details about the generation of the value tree 212 are provided, for example, in FIG. 3A, FIG. 3B, and FIG. 3C.

The computer system 202 is configured to control the set of operations associated with the implementation of the at least one strategic initiative of the set of strategic initiatives. The set of operations is controlled based on the generated value tree 212. The set of operations includes, but is not limited to, a strategic initiative data collection operation, a strategic initiative planning operation, a strategic initiative communication operation, a strategic initiative report generation operation, and a strategic initiative visualization operation. Details about the controlling of the set of operations are provided, for example, in FIG. 3A, FIG. 3B, and FIG. 3C.

In an alternative embodiment of the disclosure, the computer system 202 is configured to receive the third input data 208C that includes at least a count of a set of pain points associated with the set of value levers. Each pain point of the set of pain points corresponds to a challenge associated with the implementation of a corresponding value lever of the set of value levers. The computer system 202 is configured to receive the fourth input data 208D that includes at least a count of a set of program epics associated with at least one lever of the set of value levers. Each program epic of the set of program epics corresponds to a solution to the challenge associated with the implementation of the corresponding value lever of the set of value levers. The computer system 202 is configured to receive the fifth input data 208E which includes a count of a set of features associated with at least one program epic of the set of program epics and a set of data sources of business data associated with the business. The computer system 202 is configured to receive the sixth input data 208F that includes at least a count of a set of user stories associated with at least one feature of the set of features. Each user story of the set of user stories corresponds to one or more tasks associated with the implementation of a corresponding feature of the set of features. Details about the reception of the third input data 208C are provided, for example, in FIG. 3A, FIG. 3B, and FIG. 3C.

The computer system 202 is configured to apply the set of language models 210 on the third input data 208C, the fourth input data 208D, the fifth input data 208E, the sixth input data 208F, or any combination thereof. Details about the application of the set of language models 210 on the third input data 208C, the fourth input data 208D, the fifth input data 208E, the sixth input data 208F, or any combination thereof are provided, for example, in FIG. 3A, FIG. 3B, and FIG. 3C.

The computer system 202 is configured to determine the set of pain points, the set of program epics, the set of features, the set of user stories based on the application of the set of language models 210 on the third input data 208C, the fourth input data 208D, the fifth input data 208E, the sixth input data 208F, or any combination thereof. Details about the determination of the set of pain points, the set of program epics, the set of features, and the set of user stories are provided, for example, in FIG. 3A, FIG. 3B, and FIG. 3C.

The computer system 202 is configured to modify the value tree 212 based on the determined set of pain points, the determined set of program epics, the determined set of features, and the determined set of user stories. The modification of the value tree 212 corresponds to the inclusion of a fifth subset of nodes associated with the determined set of pain points, a sixth subset of nodes associated with the determined set of program epics, a seventh subset of nodes associated with the determined set of features, and an eight subset of nodes associated with the determined set of user stories in the value tree 212. Details about the value tree are provided, for example, in FIG. 4D

The computer system 202 is configured to output the modified value tree. In an embodiment of the disclosure, the computer system 202 is configured to output the modified value tree on the first user device 204. Details about the output of the modified value tree are provided, for example, in FIG. 3C.

FIG. 3A, FIG. 3B and FIG. 3C collectively is a diagram that illustrates exemplary operations for the generation of value trees for businesses using language models, in accordance with an embodiment of the disclosure. FIG. 3A, FIG. 3B, and FIG. 3C are explained in conjunction with elements from FIG. 1, and FIG. 2. With reference to FIG. 3A, FIG. 3B, and FIG. 3C, there is shown a block diagram 300 that illustrates exemplary operations from 302 to 360, as described herein. The exemplary operations illustrated in the block diagram 300 may start at 302 and may be performed by any computing system, apparatus, or device, such as by the computer 102 of FIG. 1 or the computer system 202 of FIG. 2. Although illustrated with discrete blocks, the exemplary operations associated with one or more blocks of the block diagram 300 may be divided into additional blocks, combined into fewer blocks, or eliminated, depending on the particular implementation.

At 302, a first input data acquisition operation is executed. In the first input data acquisition operation, the computer system 202 is configured to receive the first input data 302A. The first input data 302A includes at least the count of the set of strategic initiatives associated with a business, the domain of the business, and the focus area associated with the set of strategic initiatives. Each strategic initiative of the set of strategic initiatives corresponds to a business plan that is performed by the business to achieve a set of business goals over a time period. Further, the count of the set of strategic initiatives corresponds to a number of the strategic initiatives of the set of strategic initiatives. By way of example, and not by limitation, for an insurance-based business, the strategic initiative may be “How might we implement advanced analytics and machine learning algorithms, so that the insurance-based business can identify and prevent claim fraud more effectively, the insurance-based business will be successful when the insurance based business see a significant reduction in fraudulent claims and related losses”. By way of additional example, and not by limitation, for a cloud computing based business, the second strategic may be “How might the cloud computing based business increase the market share and a customer retention for various cloud services and products”.

The domain of the business corresponds to a field in which the business performs one or more business activities (such as research and development activities, marketing activities, customer support activities, financial management activities, and the like). The domain of the business corresponds to an industry or a sector of the business, or a market segment of the business. Additionally, the first input data 302A includes first emphasis data associated with the focus area associated with the set of strategic initiatives. The first emphasis data includes at least a description of the set of strategic initiatives. In an embodiment of the disclosure, the computer system 202 is configured to receive the first input data 302A from the user 214. The first input data 302A can be represented in the Table 1 below:

TABLE 1
First Input Data

| Serial | | Count of Set | | Focus Areas of |
|---|---|---|---|---|
| Number | | of Strategic | Domain of | Set of Strategic |
| (S. No.) | Business | Initiatives | Business | Initiatives |
| 1 | Insurance | 3 | Insurance | Reduced Losses |
| | Company | | | from Claim Fraud |
| 2 | Banking | 2 | Financial | Enhance Online |
| | Company | | Services | Banking services |
| | | | | to Improve |
| | | | | Customer |
| | | | | Accessibility |
| 3 | Cloud | 5 | Cloud | Increase Market |
| | Company | | Computing | Share and |
| | | | | Customer Retention |

At 304, a language models application operation is executed. In the language models application operation, the computer system 202 is configured to apply at least one language model of the set of language models 210 on the first input data 302A. In an embodiment of the disclosure, the computer system 202 is configured to apply at least one language model of the set of language models 210 to determine the set of strategic initiatives. As described above in FIG. 2, each language model of the set of language models 210 is pre-trained on the historical business data associated with the plurality of business. In an embodiment of the disclosure, the set of language models 210 is trained to determine the set of strategic initiatives. Specifically, the computer system 202 is configured to provide the first input data 302A, as an input, to the set of language models 210. Further, the computer system 202 is configured to determine the set of strategic initiatives based on the first input data 302A based on the application of the set of language models 210 on the first input data 302A. Details about the determination of the set of strategic initiatives based on the application of the set of language models 210 are provided below at 306.

At 306, a strategic initiatives determination operation. In the strategic initiatives determination operation, the computer system 202 is configured to determine the set of strategic initiatives based on the application of the set of language models 210 on the first input data 302A. By way of example, and not by limitation, the set of language models 210 is configured to execute sematic analysis operation on the first input data 302A that includes the count of the set of strategic initiatives associated with the business, the domain of the business, and the focus area associated with the set of strategic initiatives. The sematic analysis operation is executed to determine contextual data associated with the first input data 302A. The contextual data includes a set of identifiers associated with the domain of the business, the focus area associated with the set of strategic initiatives, or any combination thereof.

For example, referring back to table 1 at S. No. (1), the domain of the business is insurance and the focus area associated with the set of strategic initiatives is reduced losses from fraud claims, the computer system 202 is configured to determine a set of insurance identifiers associated with a context of the domain (insurance) of the business, the focus area (reduced losses from fraud claims), or any combination thereof. The set of insurance identifiers includes fraud detection, fraud prevention, Artificial Intelligence (AI)-based fraud detection, claims verification, suspicious claims, analytics claims audits, fraud analytics, and the like.

The set of language models 210 is further configured to retrieve domain-specific data based on the first input data 302A, the contextual data associated with the first input data 302A, or any combination thereof. In an embodiment of the disclosure, the set of language models 210 is further configured to retrieve the domain-specific data from a set of sources (such as databases, websites, and the like) associated with the domain of the business. Referring back to table 1 at S. No. (1), the domain of the business is insurance, the focus area associated with the set of strategic initiatives is the reduced losses from claim fraud, the set of language models 210 is configured to obtain the historical insurance claim data associated with a historical set of fraud cases. The historical insurance claim data includes a count (such as 2, 3, 4, and 5) associated with a set of insurance claims, a type (such as health insurance, motor insurance, life insurance, and the like) of each insurance claim of the set of claims, a result indicative of one of an acceptance or a denial of each insurance claim of the set of claims, one or more reasons associated with the result indicative of one of the acceptance or the denial of each insurance claim of the set of claims.

For example, referring back to table 1 at S. No. (1), the count of the set of strategic initiatives is 3, and the set of language models 210 is configured to determine the set of strategic initiatives that include three strategic initiatives based on the count (3) of the set of strategic initiatives. Further, the set of language models 210 is configured to determine the set of strategic initiatives based on the historical insurance claim data, the set of constraints, the domain-specific data, or any combination thereof. In an embodiment of the disclosure, the set of language models 210 is configured to generate the set of strategic initiatives based on the historical claim data and a set of predefined prompts. The set of predefined prompts can be represented as follows:

### “[[Name of a Strategic Initiative]]

How might we implement [[brief description of the strategic initiative]], so that we can identify and prevent claim fraud more effectively, we'll be successful when we [[a result of an application of the strategic initiative]].”

The determined set of strategic initiatives can be represented in Table 2 below:

TABLE 2
Set of Strategic Initiatives

Strategic Initiative 1
Advanced Fraud Analytics -Insurance
How might we implement advanced analytics and machine learning
algorithms, so that we can identify and prevent claim fraud more
effectively, we'll be successful when we see a significant reduction
in fraudulent claims and related losses.
Strategic Initiative 2
Enhanced Claims Investigation -Insurance
How might we strengthen the claims investigation process, so
that we can detect fraudulent activities more effectively,
we'll be successful when the number of successful fraud
investigations increases and the overall fraud rate decreases.
Strategic Initiative 3
Fraud Awareness and Training - Insurance
How might we increase fraud awareness and provide training
to employees and partners, So that we can improve the ability
to identify and report potential fraud, We'll be successful
when employees and partners demonstrate increased knowledge
and awareness of fraud indicators and reporting mechanisms.

At 308, a first input reception operation is executed. In the first input reception operation, the computer system 202 is configured to receive a first input associated with a selection of at least one strategic initiative of the determined set of strategic initiatives. In an embodiment of the disclosure, the computer system 202 is configured to receive the first input based on the determination of the set of strategic initiatives. In various embodiments of the disclosure, the computer system 202 is configured to receive the first input from the first user device 204. In various embodiments of the disclosure, the computer system 202 is configured to receive the first input to select at least one strategic initiative of the determined set of strategic initiatives.

At 310, a strategic initiatives selection operation is executed. In the strategic initiatives selection operation, the computer system 202 is configured to select at least one strategic initiative of the determined set of strategic initiatives based on the received first input. In an embodiment of the disclosure, the computer system 202 is configured to select the at least one strategic initiative to determine the set of value pools, the set of value drivers, and the set of value levers. In an embodiment of the disclosure, the computer system 202 is configured to select the at least one node of the strategic initiative to generate a value tree 318A. The value tree 318A includes a set of nodes associated with the selected at least one strategic initiative. In an embodiment of the disclosure, the computer system 202 is configured to receive the second input data 312 based on the selection of the at least one strategic initiative of the determined set of strategic initiatives.

At 312, a second input data acquisition operation is executed. In the second input data acquisition operation, the computer system 202 is configured to receive the second input data 312A. In an embodiment of the disclosure, the computer system 202 is configured to receive the second input data 312A from the first user device 204. The second input data 312A includes a count of a set of value pools associated with at least one strategic initiative of the set of strategic initiatives, a count of a set of value drivers associated with the set of value pools, and a count of a set of value levers associated with the set of value drivers. Each value pool of the set of value pools is indicative of a business segment associated with the business. The business segment represents at least one opportunity for a generation of revenue for the business or the creation of value for the business. The count of the set of value pools is indicative of the number of value pools in the set of value pools. Further, the performance of each value pool of the set of value pools and the profitability of each value pool of the set of value pools are based on the set of value drivers. The count of the set of value drivers is indicative of the number of value drivers in the set of value pools. Further, each value pool of the set of value pools is based on each value lever of the set of value levers. The count of the set of value levers is indicative of the number of value levers in the set of value levers. Additionally, the second input data 312A includes second emphasis data associated with the set of value pools, the set of value drivers, the set of value levers, or a combination thereof. The second emphasis data includes a description of the set of value pools, a description of the set of value drivers, a description of the set of value drivers, or any combination thereof. Details about the set of value pools, the set of value levers, and the set of value drivers are provided, for example, at 316.

In an embodiment of the disclosure, the computer system 202 is configured to receive the second input to generate the value tree 318A. Details about the generation of the value tree 318A are provided, for example, at 318. The second input data 312A can be represented in the Table 3 below:

TABLE 3
Second Input Data

| Count of Set | Count of Set | Count of Set |
|---|---|---|
| of Value Pools | of Value Drivers | of Value Levers |
| 3 | 3 | 3 |
| 1 | 2 | 1 |
| 4 | 7 | 8 |

At 314, a language models application operation is executed. In the language models application operation, the computer system 202 is configured to apply the set of language models 210 on the first input data 302A, the second input data 312A, or a combination thereof. In an embodiment of the disclosure, the computer system 202 is configured to apply the set of language models 210 to determine the set of value pools, the set of value drivers, and the set of value levers. In an embodiment of the disclosure, the set of language models 210 is trained to determine the set of value pools, the set of value drivers, and the set of value levers. Specifically, the computer system 202 is configured to provide the first input data 302A, and the second input data 312A, as an input, to the set of language models 210. Further, the computer system 202 is configured to determine the set of value pools, the set of value drivers, and the set of value levers based on the application of the set of language models 210 on the first input data 302A, and the second input data 312A. Details about the determination of the set of value pools, the set of value drivers, and the set of value levers based on the application of the set of language models 210 are provided, for example, at 316.

At 316, a values determination operation is executed. In the values determination operation, the computer system 202 is configured to determine the set of value pools, the set of value drivers, and the set of value levers based on the application of the set of language models 210 on the first input data 302A and the second input data 312A. The set of value pools can be represented in Table 4 below:

TABLE 4
Set of Value Pools
Insurance Segment

| Opportunity for Generation | Creation of |
|---|---|
| of Revenue for Business | Value of Business |
| Operational Efficiency | $200000 |
| and Cost | |
| Risk | $5000000 |
| User Experience | $3450000 |

Further, the computer system 202 is configured to determine the set of value drivers associated with the set of value pools. In an embodiment of the disclosure, the computer system 202 is configured to determine the set of value drivers based on the determination of the set of value pools. The set of value drivers includes a set of objectives with respect to the at least one opportunity for the generation of revenue for the business. Additionally, the set of value drivers includes a set of objective values associated with the set of objectives. Each objective value of the set of objective values is indicative of an estimated revenue that will be generated with respect to the completion of the corresponding objective of the set of objectives. The set of value drivers can be represented in Table 5 below:

TABLE 5
Set of Value Drivers

| | |
|---|---|
| | Set of |
| Set of Objectives | Objective Values |

Operational Efficiency and Cost

| | |
|---|---|
| Efficient Fraud Detection | $10000 |
| Reduced False Positive | $64000 |

Risk

| | |
|---|---|
| Improved Risk Assessment | $63700 |
| Reduced Fraud Losses | $82937 |

In an embodiment of the disclosure, the computer system 202 is configured to determine the set of value levers associated with the set of value drivers. In various embodiments of the disclosure, the computer system 202 is configured to determine the set of value levers based on the determination of the set of value drivers. The set of value levers includes a set of actions with respect to the at least one objective of the set of objectives. Additionally, the set of value levers includes a set of results that will be achieved in case of an implementation of at least one objective of the set of objectives. Further, the set of value levers includes a set of action values that is indicative of a potential value for completion of the corresponding action of the set of actions. The set of value levers can be represented in Table 6 below:

TABLE 6
Set of Value Levers

| | | | |
|---|---|---|---|
| | | | Set of |
| S. No. | Set of Actions | Set of Results | Action Values |

Efficient Fraud Detection

| | | | |
|---|---|---|---|
| 1 | Machine Learning | Increased Accuracy | $10000 |
| | Models Application | of Fraud Detection | |

Reduced False Positive

| | | | |
|---|---|---|---|
| 2 | Advanced | Decrease False | $64000 |
| | Algorithms | Positive Rates | |
| | Application | | |

At 318, a value tree generation operation is executed. In the value tree generation operation, the computer system 202 is configured to generate the value tree 318A. The value tree 212 corresponds to a hierarchal structure that decomposes the at least one strategic initiative into a set of nodes. Further, the value tree includes a set of nodes associated with the at least one strategic initiative of the set of strategic initiatives, the determined set of value pools, the determined set of value drivers, and the determined set of value levers. The value tree 318A is associated with the at least one strategic initiative. Specifically, the set of nodes includes at least a first subset of nodes associated with at least one selected strategic initiative. Further, the set of nodes includes a second subset of nodes associated with the set of value pools, a third subset of nodes associated with the set of value drivers, and a fourth subset of nodes associated with the set of value levers and the value of key levers. The first set of nodes, the second set of nodes, the third set of nodes, and the fourth set of nodes are associated with a respective layer of the value tree 318A. For example, the first layer of the value tree 318A includes the first set of nodes, a second layer of the value tree 318A includes the second set of nodes, a third layer of the value tree 318A includes the third set of nodes and a fourth layer of the value tree 318A includes the fourth set of nodes.

Further, each successive layer of the value tree 212 from the first subset of nodes is generated to align the set of nodes (the second subset of nodes, the third subset of nodes, the fourth subset of nodes, and the like) with respect to the first subset of nodes. The decomposition of the at least one strategic initiative into the set of nodes allows the user 214 to analyze a predicted profit from an implementation of the at least one strategic initiative, one or more techniques to implement the at least one strategic initiative, a priority of one or more tasks associated with the at least one strategic initiative, and the like. By way of example, and not by limitation, the value tree 212 includes the first subset of nodes indicative of the at least one strategic initiative (Advanced Fraud Analytics-Insurance), the second subset of nodes indicative of the focus area (Operational Efficiency and Cost) and a predicted revenue ($100000) by implementing the at least one strategic initiative, the third subset of nodes (Efficiency Fraud Detection) to implement the second subset of nodes, and the fourth subset of nodes (Machine Leaning Models) to implement the third subset of nodes. A pictorial representation of the value tree 318A is provided, for example, in FIG. 4D.

At 320, a value tree output operation is executed. In the value tree output operation, the computer system 202 is configured to output the value tree 318A based on the generation of the value tree 318A. In an embodiment of the disclosure, the computer system 202 is configured to output the value tree 318A on a user interface associated with the computer system 202. In various embodiments of the disclosure, the computer system 202 is configured to output the value tree 318A on the display screen 206 of the first user device 204.

At 322, a third input data acquisition operation is executed. In the third input data acquisition operation, the computer system 202 is configured to receive the third input data 322A. The third input data 322A includes at least a count of a set of pain points associated with the set of value levers. Each pain point of the set of pain points corresponds to a challenge associated with the implementation of a corresponding value lever of the set of value levers. Further, the count of the set of pain points corresponds to the number of pain points within the set of pain points. Additionally, the third input data 322A includes third emphasis data associated with the set of pain points. The third emphasis data includes a description of the set of pain points. In an embodiment of the disclosure, the computer system 202 is configured to receive the third input data 322A after the determination of the set of value pools, the set of value drivers, and the value levers. In various embodiments of the disclosure, the computer system 202 is configured to receive the third input data 322A from the user 214. The third input data 322A can be represented in the Table 7 below:

TABLE 7
Third Input Data
Count of Set of Pain Points
3

At 324, a language models application operation is executed. In the language models application operation, the computer system 202 is configured to apply the set of language models 210 on the first input data 302A, the second input data 312A, the third input data 322A, and the value tree 318A. In an embodiment of the disclosure, the computer system 202 is configured to apply the set of language models 210 to determine the set of pain points. In an embodiment of the disclosure, the set of language models 210 is trained to determine the set of pain points. Specifically, the computer system 202 is configured to provide the first input data 302A, the second input data 312A, the third input data 322A, and the value tree 318A, as an input, to the set of language models 210. Further, the computer system 202 is configured to determine the set of paint points based on the application of the set of language models 210 on the first input data 302A, the second input data 312A, the third input data 322A, and the value tree 318A. Details about the determination of the set of pain points based on the application of the set of language models 210 are provided below at 326.

At 326, a pain points determination operation is executed. In the pain points determination operation, the computer system 202 is configured to determine the set of pain points based on the application of the set of language models 210 on the first input data 302A, the second input data 312A, and the third input data 322A. Each pain point of the set of pain points corresponds to the challenge associated with the implementation of a corresponding value lever of the set of value levers. Specifically, the set of pain points includes a set of challenges associated with the corresponding action of the set of value levers. Additionally, the set of pain points includes a set of loss values associated with the corresponding action of the set of value levers. Each loss value of the set of loss values is indicative of a decrease in the corresponding action value of the set of action values. The set of pain points can be represented in Table 8 below:

TABLE 8
Set of Pain Points
Set of Value Levers (Set of Actions)
Machine learning Models Application

| | | Set of |
|---|---|---|
| S. No. | Set of Challenges | Loss Values |
| 1 | Inefficient Fraud | $10000 |
| | Detection Models | |
| 2 | Lack of Real-time | $10000 |
| | Insights | |
| 3 | Inability to Identify | $10000 |
| | Complex Fraud Patterns | |

At 328, a value tree modification operation is executed. In the value tree modification operation, the computer system 202 is configured to modify the value tree 318A based on the determined set of pain points. In an embodiment of the disclosure, the modification of the value tree 318A based on the determined set of pain points is referred to as “first modification of the value tree 318A”. Specifically, the first modification of the value tree 318A corresponds to the inclusion of the fifth subset of nodes associated with the determined set of pain points in the value tree 318A. Additionally, the set of nodes includes the fifth subset of nodes associated with the set of pain points. In an embodiment of the disclosure, a fifth layer of the value tree 318A includes the fifth subset of nodes.

At 330, a modified value tree output operation is executed. In the modified value tree output operation, the computer system 202 is configured to output the first modified value tree 330A. The first modified value tree 330A includes the first subset of nodes, the second subset of nodes, the third subset of nodes, the fourth subset of nodes, and the fifth subset of nodes. In an embodiment of the disclosure, the computer system 202 is configured to output the first modified value tree 330A based on the modification of the first modified value tree 330A. In an embodiment of the disclosure, the computer system 202 is configured to output the first modified value tree 330A on the user interface associated with the computer system 202. In various embodiments of the disclosure, the computer system 202 is configured to output the first modified value tree 330A on the display screen 206 of the first user device 204.

At 332, a fourth input data acquisition operation is executed. In the fourth input data acquisition operation, the computer system 202 is configured to receive the fourth input data 332A. The fourth input data 332A includes at least a count of a set of program epics associated with at least one value lever of the set of value levers. Each program epic of the set of program epics corresponds to a solution to the challenge associated with the implementation of the corresponding value lever of the set of value levers. Additionally, the fourth input data 332A includes fourth emphasis data associated with the set of program epics. The fourth emphasis data includes a description of the set of program epics. In an embodiment of the disclosure, the computer system 202 is configured to receive the fourth input data 332A based on the first modification of the value tree 318A based on the determined set of paint points. In various embodiments of the disclosure, the computer system 202 is configured to receive the fourth input data 332A based on the output of the first modified value tree 330A. In various embodiments of the disclosure, the computer system 202 is configured to receive the fourth input data 332A from the user 214. The fourth input data 332A can be represented in the Table 9 below:

TABLE 9
Fourth Input Data
Count of Set of Program Epics
7

At 334, a language models application operation is executed. In the language models application operation, the computer system 202 is configured to apply the set of language models 210 on the first input data 302A, the second input data 312A, the third input data 322A, the fourth input data 332A, and the first modified value tree 330A. In an embodiment of the disclosure, the computer system 202 is configured to apply the set of language models 210 to determine the set of program epics. Details about the determination of the set of program epics based on the application of the set of language models 210 are provided below at 326.

At 336, a program epics determination operation is executed. In the program epics determination operation, the computer system 202 is configured to determine the set of program epics based on the application of the set of language models 210 on the first input data 302A, the second input data 312A, the third input data 322A, the fourth input data 332A, and the first modified value tree 330A. Each program epic of the set of program epics corresponds to the solution to the challenge associated with the implementation of the corresponding value lever of the set of value levers. Additionally, an operational cost is indicative of a cost for an implementation of the corresponding epic of the set of program epics. The set of program epics can be represented in Table 10 below:

TABLE 10
Set of Program Epics

| | | Set of |
|---|---|---|
| S. No. | Set of Solutions | Solution Values |
| 1 | AI-Powered Fraud Detection | $50000 |

At 338, a value tree modification operation is executed. In the value tree modification operation, the computer system 202 is configured to modify the value tree 318A based on the determined set of program epics. In an embodiment of the disclosure, the modification of the value tree 318A based on the determined set of program epics is referred to as “second modification of the value tree 318A”. Specifically, the second modification of the value tree 318A corresponds to the inclusion of a sixth subset of nodes associated with the determined set of program epics. Additionally, the set of nodes includes the sixth subset of nodes associated with the set of program epics. In an embodiment of the disclosure, a sixth layer of the value tree 318A includes the sixth subset of nodes.

At 340, a modified value tree output operation is executed. In the modified value tree output operation, the computer system 202 is configured to output a second modified value tree 340A. The second modified value tree 340A includes the first subset of nodes, the second subset of nodes, the third subset of nodes, the fourth subset of nodes, the fifth subset of nodes, and the sixth subset of nodes. In an embodiment of the disclosure, the computer system 202 is configured to output the second modified value tree 340A based on the second modification of the value tree 318A. In an embodiment of the disclosure, the computer system 202 is configured to output the second modified value tree 340A on the user interface associated with the computer system 202. In various embodiments of the disclosure, the computer system 202 is configured to output the second modified value tree 340A on the display screen 206 of the first user device 204. In an embodiment of the disclosure, the computer system 202 is configured to execute at least one solution of the set of solutions. The computer system 202 is configured to execute at least one solution of the set of solutions to resolve the corresponding pain point of the set of pain points.

At 342, a fifth input data acquisition operation is executed. In the fifth input data acquisition operation, the computer system 202 is configured to receive the fifth input data 342A. The fifth input data 342A includes at least a count of a set of features associated with at least one program epic of the set of program epics and a set of data sources of business data associated with the business. Each feature of the set of features corresponds to one or more characteristics associated with a corresponding program epic of the set of program epics. Additionally, the fifth input data 342A includes fifth emphasis data associated with the set of features. The fifth emphasis data includes a description of the set of features. In an embodiment of the disclosure, the computer system 202 is configured to receive the fifth input data 342A based on the second modification of the value tree 318A with respect to the determined set of program epics. In various embodiments of the disclosure, the computer system 202 is configured to receive the fifth input data 342A based on the output of the second modified value tree 340A. In various embodiments of the disclosure, the computer system 202 is configured to receive the fifth input data 342A from the user 214. The fifth input data 342A can be represented in the Table 11 below:

TABLE 11
Fourth Input Data
Count of Set of Features
4

At 344, a language models application operation is executed. In the language models application operation, the computer system 202 is configured to apply the set of language models 210 on the first input data 302A, the second input data 312A, the third input data 322A, the fourth input data 332A, the fifth input data 342A, and the second modified value tree 340A. In an embodiment of the disclosure, the computer system 202 is configured to apply the set of language models 210 to determine the set of features. In an embodiment of the disclosure, the set of language models 210 is trained to determine the set of features. Specifically, the computer system 202 is configured to provide the first input data 302A, the second input data 312A, the third input data 322A, the fourth input data 332A, the fifth input data 342A, and the second modified value tree 340A, as an input, to the set of language models 210. Further, the computer system 202 is configured to determine the set of features based on the application of the set of language models on the first input data 302A, the second input data 312A, the third input data 322A, the fourth input data 332A, the fifth input data 342A, and the value tree 318A. Details about the determination of the set of features based on the application of the set of language models 210 are provided below at 326.

At 346, a features determination operation is executed. In the features determination operation, the computer system 202 is configured to determine the set of features based on the application of the set of language models 210 to the first input data 302A, the second input data 312A, the third input data 322A, the fourth input data 332A, the fifth input data 342A and the second modified value tree 340A. Each feature of the set of features corresponds to one or more characteristics associated with the corresponding program epic of the set of program epics. The set of features can be represented in Table 12 below:

TABLE 12
Set of Features

| S. No. | Set of Features |
|---|---|
| 1 | Integration of AI-powered fraud detection system with |
| | Salesforce Service Cloud and Salesforce Einstein |
| | Leveraging WatsonX and WatsonX Orchestrate for advanced |
| | Analytics and Decision Making Real-time Monitoring and |
| | Analysis of Transactions to Identify Potential Fraud Patterns |

At 348, a value tree modification operation is executed. In the value tree modification operation, the computer system 202 is configured to modify the value tree 318A based on the determined set of features. In an embodiment of the disclosure, the modification of the value tree 318A based on the determined set of features is referred to as “third modification of the value tree 318A”. Specifically, the third modification of the value tree 318A corresponds to the inclusion of a seventh subset of nodes associated with the set of program epics. Additionally, the set of nodes includes the seventh subset of nodes. In an embodiment of the disclosure, a seventh layer of the value tree 318A includes the seventh subset of nodes.

At 350, a modified value tree output operation is executed. In the modified value tree output operation, the computer system 202 is configured to output a third modified value tree 350A. The third modified value tree 350A includes the first subset of nodes, the second subset of nodes, the third subset of nodes, the fourth subset of nodes, the fifth subset of nodes, the sixth subset of nodes, and the seventh subset of nodes. In an embodiment of the disclosure, the computer system 202 is configured to output the third modified value tree 350A based on the third modification of the value tree 318A. In an embodiment of the disclosure, the computer system 202 is configured to output the third modified value tree 350A on the user interface associated with the computer system 202. In various embodiments of the disclosure, the computer system 202 is configured to output the third modified value tree 350A on the display screen 206 of the first user device 204.

At 352, a sixth input data acquisition operation is executed. In the sixth input data acquisition operation, the computer system 202 is configured to receive the sixth input data 352A. The sixth input data 352A includes at least a count of a set of user stories associated with at least one feature of the set of features. Each user story of the set of user stories corresponds to one or more tasks associated with the implementation of a corresponding feature of the set of features. Additionally, the sixth input data 352A includes sixth emphasis data associated with the set of user stories. The sixth emphasis data includes a description of the set of user stories. In an embodiment of the disclosure, the computer system 202 is configured to receive the sixth input data 352A based on the third modification of the value tree 318A with respect to the determined set of features. In various embodiments of the disclosure, the computer system 202 is configured to receive the sixth input data 352A based on the output of the third modified value tree 350A. In various embodiments of the disclosure, the computer system 202 is configured to receive the sixth input data 352A from the user 214. The sixth input data 352A can be represented in the Table 13 below:

TABLE 13
Set of User Stories
Count of Set of User Stories
4

At 354, a language models application operation is executed. In the language models application operation, the computer system 202 is configured to apply the set of language models 210 on the first input data 302A, the second input data 312A, the third input data 322A, the fourth input data 332A, the fifth input data 342A, the sixth input data 352A, and the third modified value tree 350A. In an embodiment of the disclosure, the computer system 202 is configured to receive a second input associated with the creation of at least one feature of the set of features. In an embodiment of the disclosure, the computer system 202 is configured to receive the second input from the first user device 204. Further, the computer system 202 is configured to apply the set of language models based on the reception of the second input. In an embodiment of the disclosure, the computer system 202 is configured to apply the set of language models 210 to determine the set of user stories. In an embodiment of the disclosure, the set of language models 210 is trained to determine the set of user stories. Specifically, the computer system 202 is configured to provide the first input data 302A, the second input data 312A, the third input data 322A, the fourth input data 332A, the fifth input data 342A, the sixth input data 352A, and the third modified value tree 350A, as an input, to the set of language models 210. Further, the computer system 202 is configured to determine the set of user stories based on the application of the set of language models 210 on the first input data 302A, the second input data 312A, the third input data 322A, the fourth input data 332A, the fifth input data 342A, the sixth input data 352A and the third modified value tree 350A. Details about the determination of the set of user stories based on the application of the set of language models 210 are provided below at 356.

At 356, a user stories determination operation is executed. In the user stories determination operation, the computer system 202 is configured to determine the set of user stories based on the application of the set of language models 210 to the first input data 302A, the second input data 312A, the third input data 322A, the fourth input data 332A, the fifth input data 342A, the sixth input data 352A, and the third modified value tree 350A. Each user story of the set of user stories corresponds to one or more tasks associated with the implementation of the corresponding feature of the set of features. The set of features can be represented in Table 14 below:

TABLE 14
Set of User Stories

Set of User Stories
Implement AI powered Fraud Detection Model

At 358, a value tree modification operation is executed. In the value tree modification operation, the computer system 202 is configured to modify the value tree 318A based on the determined set of user stories. In an embodiment of the disclosure, the modification of the value tree 318A based on the determined set of user stories is referred to as “fourth modification of the value tree 318A”. Specifically, the fourth modification of the value tree 318A corresponds to the inclusion of an eighth subset of nodes associated with the determined set of user stories. Additionally, the set of nodes includes the eighth subset of nodes. In an embodiment of the disclosure, an eighth layer of the value tree 318A includes the eighth subset of nodes.

At 360, a modified value tree output operation is executed. In the modified value tree output operation, the computer system 202 is configured to output a fourth modified value tree 360A. The fourth modified value tree 360A includes the first subset of nodes, the second subset of nodes, the third subset of nodes, the fourth subset of nodes, the fifth subset of nodes, the sixth subset of nodes, the seventh subset of nodes, and the eighth subset of nodes. In an embodiment of the disclosure, the computer system 202 is configured to output the fourth modified value tree 360A based on the fourth modification of the value tree 318A. In an embodiment of the disclosure, the computer system 202 is configured to output the fourth modified value tree 360A on the user interface associated with the computer system 202. In various embodiments of the disclosure, the computer system 202 is configured to output the fourth modified value tree 360A on the display screen 206 of the first user device 204.

At 362, a control operation is executed. In the control operation, the computer system 202 is configured to control the set of operations associated with the implementation of the at least one strategic initiative of the set of strategic initiatives. The set of operations is controlled based on the generated value tree 318A. In an embodiment of the disclosure, the computer system 202 is configured to control the set of operations based on the generated value tree 318A, the first modified value tree 330A, the second modified value tree 340A, the third modified value tree 350A, the fourth modified value tree 360A, or any combination thereof.

In an embodiment of the disclosure, the computer system 202 is configured to automatically execute each operation of the set of operations based on the generated value tree 318A, the first modified value tree 330A, the second modified value tree 340A, the third modified value tree 350A, the fourth modified value tree 360A, or any combination thereof. The set of operations includes a strategic initiative data collection operation, a strategic initiative planning operation, a strategic initiative communication operation, a strategic initiative report generation operation, and a strategic initiative visualization operation.

The set of operations includes, but is not limited to, the strategic initiative data collection operation, the strategic initiative planning operation, the strategic initiative communication operation, the strategic initiative report generation operation, and the strategic initiative visualization operation. In the strategic initiative data collection operation, the computer system 202 is configured to collect strategic initiative data associated with the at least one strategic initiative from one or more sources (such as a database, a website, and the like). The one or more sources are associated with the at least one strategic initiative. The strategic initiative data includes a set of goals (such as revenue growth, a market innovation, a product innovation, and the like) associated with at least one strategic initiative, a set of key performance indicators (such as a revenue growth percentage, a customer retention rate, an operational cost, and the like) that is indicative of success of the at least one strategic initiative, a duration (such as 10 days, 1 month, 3 months, 6 months, 1 year, 5 years and the like) for completion of the at least one strategic initiative. In the strategic initiative planning operation, the computer system 202 is configured to determine a set of plans to complete the at least one strategic initiative.

In an embodiment of the disclosure, the computer system 202 is configured to determine the set of plans based on an application of the set of language models 210 on the strategic initiative data. The set of plans includes a priority of one or more tasks associated with the at least one strategic initiative, a set of resources (such as the number of workers, an identifier of computational resources (such as computers, cloud storage spaces, and the like)) for the completion of the at least one strategic initiative. In the strategic initiative communication operation, the computer system 202 is configured to establish a communication between each entity of a set of entities (such as a set of workers, a set of users, and a set of devices) associated with the at least one strategic initiative. In the strategic initiative report generation operation, the computer system 202 is configured to generate a set of reports associated with the at least one strategic initiative. The set of reports includes, but is not limited to, a monthly goal report for the at least one strategic initiative, a quarterly goal report for the at least one strategic initiative, and a yearly goal report for the at least one strategic initiative. In the strategic initiative visualization operation, the computer system 202 is configured to render visualization data associated with the at least one strategic initiative. For example, the visualization data corresponds to a set of tables, a set of pie graphs, a set of bar graphs, a set of line graphs, and the like. The visualization data is indicative of a status (such as a complete status, an incomplete status, or a not-picked status) for each process of the one or more tasks, the performance of each worker of the set of workers, and the like.

FIG. 4A is a diagram that illustrates an exemplary first user interface for the reception of first input data, in accordance with an embodiment of the disclosure. FIG. 4A is explained in conjunction with elements from FIG. 1, FIG. 2, FIG. 3A, FIG. 3B, and FIG. 3C. With reference to FIG. 4A, there is shown an exemplary diagram 400A that includes a user device 402 and an exemplary first input page 404. The exemplary first input page 404 includes a first user interface (UI) element 406, a second UI element 408, a third UI element 410, a fourth UI element 412, a fifth UI element 414, a sixth UI element 416, and a seventh UI element 418. The user device 402 is an example embodiment of the first user device 204 of FIG. 2.

With reference to FIG. 4A, the computer system 202 is configured to receive one or more inputs from the user device 402. The user device 402 includes the display screen 206 that renders the exemplary first input page 404 on the user device 402 to be seen by the user 214. In an embodiment, the exemplary first input page 404 corresponds to a web page or an online form that is designed to collect information from the user 214 who wishes to generate the value tree 212. In an embodiment of the disclosure, the exemplary first input page 404 is used to gather relevant data from the user 214 to generate the value tree 212.

The first UI element 406 corresponds to a textbox that includes a message for the user 214, for example, “Hey, please fill in three questions below and we'll generate the Strategic Initiatives title and statement automatically based on the key information”. The first UI element 406 further includes the second UI element 408, the third UI element 410, the fourth UI element 412, the fifth UI element 414, the sixth UI element 416, and the seventh UI element 418. The second UI element 408 corresponds to a textbox labeled “How many Strategic Initiatives do you want?”. The second UI element 408 is configured to receive the count associated with the set of strategic initiatives.

The third UI element 410 corresponds to a textbox labeled “What is your business or industry?”. The third UI element 410 is configured to receive the information about the domain of the business. The fourth UI element 412 corresponds to a textbox labeled “What is the focus area?”. The fourth UI element 412 is configured to receive the focus area associated with the set of strategic initiatives. The fifth UI element 414 corresponds to a textbox labeled “Enter the emphasis with clear objective, detailed description, highlight key points and contextual examples to help AI understand your specific needs”. The fifth UI element 414 is configured to receive the first emphasis data associated with the context of the focus area. In an embodiment, the first emphasis data may be optional.

The sixth UI element 416 corresponds to a button and is labeled as “Cancel”. Upon selection of the sixth UI element 416, the computer system 202 is configured to halt the generation of the value tree 212. The seventh UI element 418 corresponds to a button and is labeled as “Next”. Upon selecting the seventh UI element 418, the computer system 202 is configured to render an exemplary selection page 420 displayed in FIG. 4B.

FIG. 4B is a diagram that illustrates an exemplary second user interface for the selection of at least one of a determined set of strategic initiatives, in accordance with an embodiment of the disclosure. FIG. 4B is explained in conjunction with elements from FIG. 1, FIG. 2, FIG. 3A, FIG. 3B, FIG. 3C, and FIG. 4A. With reference to FIG. 4B, there is shown an exemplary diagram 400B that includes the user device 402 and the exemplary selection page 420. The exemplary selection page 420 includes an eighth UI element 422 that includes a ninth UI element 424, a tenth UI element 426, an eleventh UI element 428, a twelfth UI element 430, a thirteenth UI element 432, and a fourteenth UI element 434. The user device 402 is an example embodiment of the first user device 204 of FIG. 2.

With reference to FIG. 4B, the computer system 202 is configured to render the exemplary selection page 420 on the exemplary second user interface. The user device 402 includes the display screen 206 that renders the exemplary selection page 420 to the user 214. The computer system 202 is configured to render the exemplary selection page 420 on the UI of the user device 402. The exemplary selection page 420 corresponds to a web page or online form that is designed to display the determined set of strategic initiatives.

The eighth UI element 422 corresponds to a set of textboxes labeled as

### “Preview Strategic Initiative

Please review the following Strategic Initiative generated and select to create, you can regenerate all if they do not meet your needs, or your needs, or you can go back, to the previous page to modify the information”. The eighth UI element 422 is configured to render each strategic initiative of the determined set of strategic initiatives.

The ninth UI element 424 corresponds to a textbox labeled as

### “Strategic Initiative 1

### Advanced Fraud Analytics—Insurance

How might we implement advanced analytics and machine learning algorithms, So that we can identify and prevent claim fraud more effectively. We'll be successful when we see a significant reduction in fraudulent claims and related losses”. The ninth UI element 424 is configured to render the first strategic initiative of the determined set of strategic initiatives.

Additionally, the ninth UI element 424 includes a UI element 424A that is configured to receive a first user input from the user 214. The first user input is indicative of the selection of the first strategic initiative. In an embodiment of the disclosure, the UI element 424A corresponds to a first checkbox that is configured to receive the first input as a click from the user 214.

The tenth UI element 426 corresponds to a textbox labeled as

### “Strategic Initiative 2

### Enhanced Claims Investigation—Insurance

How might we strengthen the claims investigation process, So that we can detect and deter fraudulent activities more effectively. We'll be successful when the number of successful fraud investigations increases and the overall fraud rate decreases”. The tenth UI element 426 is configured to render a second strategic initiative of the determined set of strategic initiatives.

Additionally, the tenth UI element 426 includes a UI element 426A that is configured to receive a second user input from the user 214. The second user input is indicative of the selection of the second strategic initiative. In an embodiment of the disclosure, the UI element 426A corresponds to a second checkbox that is configured to receive the second input as a click from the user 214.

The eleventh UI element 428 corresponds to a textbox labeled as

### “Strategic Initiative 3

### Fraud Awareness and Training—Insurance

How might we increase fraud awareness and provide training to employees and partners, So that we can improve the ability to identify and report potential fraud, We'll be successful when employees and partners demonstrate increased knowledge and awareness of fraud indicators and reporting mechanisms”. The eleventh UI element 428 is configured to render a third strategic initiative of the determined set of strategic initiatives.

Additionally, the eleventh UI element 428 includes an UI element 428A that is configured to receive a third user input from the user 214. The third user input is indicative of the selection of the third strategic initiative. In an embodiment of the disclosure, the UI element 428A corresponds to a third checkbox that is configured to receive the third input as a click from the user 214.

The twelfth UI element 430 corresponds to a button and is labeled as “Cancel”. Upon selection of the twelfth UI element 430, the computer system 202 is configured to halt the generation of the value tree 212. The thirteenth UI element 432 corresponds to a button and is labeled as “Back”. The thirteenth UI element 432 is configured to render the exemplary first input page 404. The fourteenth UI element 434 corresponds to a button and is labeled as “Create”. Upon selecting the fourteenth UI element 434, the computer system 202 is configured to render an exemplary second input page 436 displayed in FIG. 4C.

FIG. 4C is a diagram that illustrates an exemplary third user interface for the reception of second input data, in accordance with an embodiment of the disclosure. FIG. 4C is explained in conjunction with elements from FIG. 1, FIG. 2, FIG. 3A, FIG. 3B, FIG. 3C, FIG. 4A, and FIG. 4B. With reference to FIG. 4C, there is shown an exemplary diagram 400C that includes the user device 402 and the exemplary second input page 436. The exemplary second input page 436 includes a fifteenth UI element 438 that includes, a sixteenth UI element 440, a seventeenth UI element 442, an eighteenth UI element 444, a nineteenth UI element 446, a twentieth UI element 448, and a twenty-first UI element 450.

With reference to FIG. 4C, the computer system 202 is configured to render the exemplary second input page 436 on the exemplary third user interface. The user device 402 includes the display screen 206 that renders the exemplary second input page 436 to the user 214. The computer system 202 is configured to render the exemplary second input page 436 on the UI of the user device 402. The exemplary second input page 436 corresponds to a web page or online form that is designed to receive the second input data 312A. The fifteenth UI element 438 corresponds to a set of textboxes labeled ““Generate value tree with AI” and “Input the number for each value factors””. The fifteenth UI element 438 is configured to receive the second input data 312A from the user 214. The sixteenth UI element 440 corresponds to a textbox labeled ““Number of Value Pool””. The sixteenth UI element 440 is configured to receive the count of the set of value pools.

The seventeenth UI element 442 corresponds to a textbox labeled ““Number of value drivers for each value pool””. The seventeenth UI element 442 is configured to receive the count of the set of value drivers. The eighteenth UI element 444 corresponds to a textbox labeled ““Number of value levers for each value driver””. The eighteenth UI element 444 is configured to receive the count of the set of value levers. The nineteenth UI element 446 corresponds to a textbox labeled ““Number of key metrics for each value lever””. The nineteenth UI element 446 is configured to receive the count of the set of key levers.

The twentieth UI element 448 corresponds to a button and is labeled as “Cancel”. Upon selection of the twentieth UI element 448, the computer system 202 is configured to halt the generation of the value tree 212. The twenty-first UI element 450 corresponds to a button and is labeled as “Generate”. Upon selecting the twenty-first UI element 450, the computer system 202 is configured to render an exemplary output page 452 displayed in FIG. 4C.

FIG. 4D is a diagram that illustrates an exemplary fourth user interface for rendering a value tree, in accordance with an embodiment of the disclosure. FIG. 4D is explained in conjunction with elements from FIG. 1, FIG. 2, FIG. 3A, FIG. 3B, FIG. 3C, FIG. 4A, FIG. 4B, and FIG. 4C. With reference to FIG. 4D, there is shown an exemplary diagram 400D that includes the user device 402 and an exemplary output page 452. The exemplary output page 452 includes a value tree 454 that includes a first subset of nodes associated with the set of strategic initiatives 456, a second subset of nodes associated with the set of value pools 458, a third subset of nodes associated with the set of value drivers 460, a fourth subset of nodes associated with the set of value levers 462, a fifth subset of nodes associated with the set of pain points 464, a sixth subset of nodes associated with the set of program epics 466, a seventh subset of nodes associated with the set of features 468, and an eighth subset of nodes associated with the set of user stories 470.

With reference to FIG. 4D, the computer system 202 is configured to render the exemplary output page 452 on the exemplary third user interface. The user device 402 includes the display unit that renders the exemplary output page 452 to the user 214. The computer system 202 is configured to render the exemplary output page 452 on the user interface (UI) of the user device 402. The exemplary output page 452 corresponds to a web page or online form that is designed to display the updated value tree.

The set of strategic initiatives 456 includes a node 456A labeled as “Advanced Fraud Analytics-insurance”. The set of value pools 458 includes a node 458A labeled as “Operational Efficiency and Cost” and a node 458B labeled as “Risk”. The set of value drivers 460 includes a node 460A labeled as ““Collapse” “Efficient Fraud Detection” and “Reduced False Positive””. The node 460A is associated with the node 458A. The third subset of nodes labeled includes a node 460B labeled as ““Collapse” “Improved Risk Assessment” and “Reduced Fraud Losses””. The node 460B is associated with the node 458B.

The set of value levers 462 includes a node 462A labeled as ““Collapse” “Machine Learning Models” “Accuracy of Fraud Detection” “Advanced Algorithms” and “False Positive Rate””. The node 462A is associated with the node 460A. The set of value levers 462 further includes a node 462B labeled as ““Collapse” “Data-driven insights” “Risk Assessment Accuracy” “Early Fraud Detection” and “Fraud Loss Reduction””. The node 462B is associated with the node 460B. The set of pain points 464 includes a node 464A labeled as “Insufficient Fraud Detection Models”. The node 464A is associated with the node 462A. The set of pain points 464 further includes a node 464B labeled as “Lack of Real-time insights”. The node 464B is associated with the node 462A. The set of program epics 466 includes a node 466A labeled as “AI-Powered Fraud Detection”. The node 466A is associated with the node 464A and the node 464B.

The set of features 468 includes a node 468A labeled as “Integration of AI-powered fraud detection system with Salesforce Service Cloud and Salesforce Einstein”. The set of features 468 further includes a node 468B labeled as “Levering WatsonX and Watson Orchestrate for advanced analysis and decision making”. The set of features 468 further includes a node 468C labeled as “Real-time monitoring and analysis of transactions to identify potential fraud patterns”. The set of user stories 470 includes a node 470A labeled as “Implement AI-Powered Fraud Detection Model”.

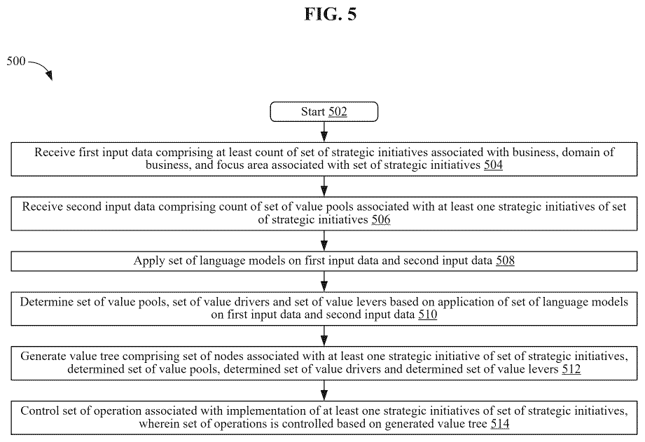

FIG. 5 is a diagram that illustrates a flowchart 500 of a method for the generation of value trees for businesses using language models, in accordance with an embodiment of the disclosure. FIG. 5 is explained in conjunction with elements from FIG. 1, FIG. 2, FIG. 3A, FIG. 3B, FIG. 3C, FIG. 4A, FIG. 4B, FIG. 4C, and FIG. 4D. The operations of the method depicted by the flowchart 500 may be executed by any computing system, for example, by the computer 102 of FIG. 1 or the computer system 202 of FIG. 2. The operations of the flowchart 500 may start at 502.

At 504, the first input data 302A is received. The first input data 302A includes at least the count of the set of strategic initiatives associated with the business, the domain of the business, and the focus area associated with the set of strategic initiatives. In an embodiment of the disclosure, the computer system 202 is configured to receive the first input data 302A that includes the count of the set of strategic initiatives associated with the business, the domain of the business, and the focus area associated with the set of strategic initiatives. Details about the reception of the first input data 302A are provided, for example, in FIG. 3A, FIG. 3B, and FIG. 3C.

At 506, the second input data 312A is received. The second input data 312A includes the count of the set of value pools associated with the at least one strategic initiative of the set of strategic initiatives, the count of the set of value drivers associated with the set of value pools, and the count of the set of value levers associated with the set of value drivers. In an embodiment of the disclosure, the computer system 202 is configured to receive the second input data 312A that includes the count of the set of value pools associated with the at least one strategic initiative of the set of strategic initiatives, the count of the set of value drivers associated with the set of value pools, and the count of the set of value levers associated with the set of value drivers. Details about the acquisition of the second input data 312A are provided, for example, in FIG. 3A, FIG. 3B, and FIG. 3C.

At 508, the set of language models 210 is applied on the first input data 302A and the second input data 312A. In an embodiment of the disclosure, the computer system 202 is configured to apply the set of language models 210 on the first input data 302A, and the second input data 312A. Details about the application of the set of language models 210 are provided, for example, in FIG. 3A, FIG. 3B, and FIG. 3C.

At 510, the set of value pools, the set of value drivers, and the set of value levers are determined based on the application of the set of language models 210 on the first input data 302A, and the second input data 312A. In an embodiment of the disclosure, the computer system 202 is configured to determine the set of value pools, the set of value drivers, and the set of value levers based on the application of the set of language models 210 on the first input data 302A and the second input data 312A. Details about the determination of the set of value pools, the set of value drivers, and the set of value levers are provided, for example, in FIG. 3A, FIG. 3B, and FIG. 3C.

At 512, the value tree 212 is generated. The value tree 212 includes the set of nodes associated with the at least one strategic initiative of the set of strategic initiatives, the determined set of value pools, the determined set of value drivers, and the determined set of value levers. The value tree 212 is associated with the at least one strategic initiative. In an embodiment of the disclosure, the computer system 202 is configured to generate the value tree 212 that includes the set of nodes associated with the at least one strategic initiative of the set of strategic initiatives, the determined set of value pools, the determined set of value drivers, and the determined set of value levers. Details about the generation of the value tree 212 are provided, for example, in FIG. 3A, FIG. 3B, and FIG. 3C.

At 514, the set of operations is controlled. The set of operations is associated with the implementation of the at least one strategic initiative of the set of strategic initiatives. The set of operations is controlled based on the generated value tree 212. In an embodiment of the disclosure, the computer system 202 is configured to control the set of operations associated with the implementation of the at least one strategic initiative of the set of strategic initiatives. The set of operations is controlled based on the generated value tree. Details about the controlling of the set of operations are provided, for example, in FIG. 3A, FIG. 3B, and FIG. 3C.

While the above operations shown in FIG. 5 are described in a particular sequence, the operations may occur in variations to the sequence in accordance with various embodiments of the present disclosure. Further, details related to various operations of FIG. 5 which are already covered in the description related to FIG. 1, FIG. 2, FIG. 3A, FIG. 3B, FIG. 3C, FIG. 4A, FIG. 4B, FIG. 4C and FIG. 4D is not discussed again in detail here for the sake of brevity.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a computer, first input data comprising at least a count of a set of strategic initiatives associated with a business, a domain of the business, and a focus area associated with the set of strategic initiatives;
receiving, by the computer, second input data comprising a count of a set of value pools associated with at least one strategic initiative of the set of strategic initiatives, a count of a set of value drivers associated with the set of value pools, and a count of a set of value levers associated with the set of value drivers;
applying, by the computer, a set of language models on the first input data and the second input data;
determining, by the computer, the set of value pools, the set of value drivers, and the set of value levers based on the application of the set of language models on the first input data and the second input data;
generating, by the computer, a value tree comprising a set of nodes associated with the at least one strategic initiative of the set of strategic initiatives, the determined set of value pools, the determined set of value drivers, and the determined set of value levers, wherein the value tree is associated with the at least one strategic initiative; and
controlling, by the computer, a set of operations associated with an implementation of the at least one strategic initiative of the set of strategic initiatives, wherein the set of operations is controlled based on the generated value tree.

2. The computer-implemented method of claim 1, wherein each value pool of the set of value pools is indicative of a business segment associated with the business, and wherein the business segment represents at least one opportunity for generation of revenue for the business or a creation of a value of the business.

3. The computer-implemented method of claim 1, wherein a performance of each value pool of the set of value pools and a profitability of each value pool of the set of value pools are based on the set of value drivers.

4. The computer-implemented method of claim 1, wherein each value pool of the set of value pools is based on each value lever of the set of value levers.

5. The computer-implemented method of claim 1, further comprising:
applying, by the computer, the set of language models on the first input data;
determining, by the computer, the set of strategic initiatives based on the application of the set of language models on the first input data;
receiving, by the computer, a first input associated with a selection of the at least one strategic initiative of the determined set of strategic initiatives; and
selecting, by the computer, the at least one strategic initiative of the determined set of strategic initiatives based on the received first input.

6. The computer-implemented method of claim 5, wherein the second input data comprises a count of a set of key levers associated with the set of value levers, and wherein the set of nodes is associated with the set of key levers associated with the set of value levers.

7. The computer-implemented method of claim 6, wherein the set of nodes comprises at least a first subset of nodes associated with the at least one strategic initiative, a second subset of nodes associated with a set of value pools, a third subset of nodes associated with a set of value drivers, and a fourth subset of nodes associated with the set of value levers and the set of key levers.

8. The computer-implemented method of claim 6, further comprising:
receiving, by the computer, third input data comprising at least a count of a set of pain points associated with the set of value levers;
applying, by the computer, the set of language models on the first input data, the second input data, the third input data, and the value tree;
determining, by the computer, the set of pain points based on the application of the set of language models on the first input data, the second input data, the third input data, and the value tree;
modifying, by the computer, the value tree based on the determined set of pain points, wherein the modification of the value tree corresponds to an inclusion of a fifth subset of nodes associated with the determined set of pain points, and wherein the set of nodes comprises the fifth subset of nodes; and
outputting, by the computer, the modified value tree.

9. The computer-implemented method of claim 8, wherein each pain point of the set of pain points corresponds to a challenge associated with an implementation of a corresponding value lever of the set of value levers.

10. The computer-implemented method of claim 9, further comprising:
receiving, by the computer, fourth input data comprising at least a count of a set of program epics associated with at least one lever of the set of value levers;
applying, by the computer, the set of language models on the first input data, the second input data, the third input data, the fourth input data, and the value tree;
determining, by the computer, the set of program epics based on the application of the set of language models on the first input data, the second input data, the third input data, the fourth input data, and the value tree;
modifying, by the computer, the value tree based on the determined set of program epics, wherein the modification of the value tree corresponds to an inclusion of a sixth subset of nodes associated with the determined set of program epics, and wherein the set of nodes comprises the sixth subset of nodes; and
outputting, by the computer, the modified value tree.

11. The computer-implemented method of claim 10, wherein each program epic of the set of program epics corresponds to a solution to the challenge associated with the implementation of the corresponding value lever of the set of value levers.

12. The computer-implemented method of claim 11, further comprising:
receiving, by the computer, fifth input data comprising at least a count of a set of features associated with at least one program epic of the set of program epics and a set of data sources of business data associated with the business;
applying, by the computer, the set of language models on the first input data, the second input data, the third input data, the fourth input data, the fifth input data, and the value tree;
determining, by the computer, the set of features based on the application of the set of language models on the first input data, the second input data, the third input data, the fourth input data, the fifth input data, and the value tree;
modifying, by the computer, the value tree based on the determined set of features, wherein the modification of the value tree corresponds to an inclusion of a seventh subset of nodes associated with the set of program epics, and wherein the set of nodes comprises the seventh subset of nodes; and
outputting, by the computer, the modified value tree.

13. The computer-implemented method of claim 12, wherein each feature of the set of features corresponds to one or more characteristics associated with a corresponding program epic of the set of program epics.

14. The computer-implemented method of claim 12, further comprising:
receiving, by the computer, sixth input data comprising at least a count of a set of user stories associated with at least one feature of the set of features;
applying, by the computer, the set of language models on the first input data, the second input data, the third input data, the fourth input data, the fifth input data, the sixth input data, and the value tree;
determining, by the computer, the set of user stories based on the application of the set of language models on the first input data, the second input data, the third input data, the fourth input data, the fifth input data, the sixth input data, and the value tree;
modifying, by the computer, the value tree based on the determined set of user stories, wherein the modification of the value tree corresponds to an inclusion of an eighth subset of nodes associated with the determined set of user stories, and wherein the set of nodes comprises the sixth subset of nodes comprises the eighth subset of nodes; and
outputting, by the computer, the modified value tree.

15. The computer-implemented method of claim 14, wherein each user story of the set of user stories corresponds to one or more tasks associated with an implementation of a corresponding feature of the set of features.

16. The computer-implemented method of claim 14, further comprising:
receiving, by the computer, a second input associated with a creation of at least one feature of the set of features;
applying, by the computer, the set of language models on the first input data, the second input data, the third input data, the fourth input data, the fifth input data, the sixth input data, the second input, and the value tree;
creating, by the computer, the at least one feature of the set of features based on the application of the set of language models on the first input data, the second input data, the third input data, the fourth input data, the fifth input data, the sixth input data, the second input, and the value tree;
modifying, by the computer, the value tree based on the creation of the at least one feature, wherein the modification of the value tree corresponds to an inclusion of at least one node in the eighth subset of nodes associated with the set of user stories, and wherein the at least one node in the eighth subset is associated with the created at least one feature; and
outputting, by the computer, the modified value tree.

17. The computer-implemented method of claim 14, wherein the first input data comprises of first emphasis data, the second input data comprises of second emphasis data, the third input data comprises of third emphasis data, the fourth input data comprises of fourth emphasis data, the fifth input data comprises of fifth emphasis data, and the sixth input data comprises of sixth emphasis data.

18. The computer-implemented method of claim 1, wherein each language model of the set of language models is pre-trained on historical business data associated with a plurality of businesses.

19. A computer system, comprising:
a processor set;
one or more computer-readable storage media; and
program instructions stored on the one or more computer-readable storage media, the program instructions executable by the processor set to cause the processor set to:
receive first input data comprising at least a count of a set of strategic initiatives associated with a business, a domain of the business, and a focus area associated with the set of strategic initiatives;
receive second input data comprising a count of a set of value pools associated with at least one strategic initiative of the set of strategic initiatives, a count of a set of value drivers associated with the set of value pools, and a count of a set of value levers associated with the set of value drivers;
apply a set of language models on the first input data and the second input data;
determine the set of value pools, the set of value drivers, and the set of value levers based on the application of the set of language models on the first input data and the second input data;
generate a value tree comprising a set of nodes associated with the at least one strategic initiative of the set of strategic initiatives, the determined set of value pools, the determined set of value drivers, and the determined set of value levers, wherein the value tree is associated with the at least one strategic initiative; and
control a set of operations associated with an implementation of the at least one strategic initiative of the set of strategic initiatives, wherein the set of operations is controlled based on the generated value tree.

20. A computer program product for generation of a value tree associated with at least strategic initiative of one set of strategic initiatives associated with a business, the computer program product comprising:
one or more computer-readable storage media; and
program instructions stored on the one or more computer-readable storage media to perform operations comprising:
receiving first input data comprising at least a count of a set of strategic initiatives associated with the business, a domain of the business, and a focus area associated with the set of strategic initiatives;
receiving second input data comprising a count of a set of value pools associated with the at least one strategic initiative of the set of strategic initiatives, a count of a set of value drivers associated with the set of value pools, and a count of a set of value levers associated with the set of value drivers;
applying a set of language models on the first input data and the second input data;
determining the set of value pools, the set of value drivers, and the set of value levers based on the application of the set of language models on the first input data and the second input data;
generating the value tree comprising a set of nodes associated with the at least one strategic initiative of the set of strategic initiatives, the determined set of value pools, the determined set of value drivers, and the determined set of value levers, wherein the value tree is associated with the at least one strategic initiative; and
controlling a set of operations associated with an implementation of the at least one strategic initiative of the set of strategic initiatives, wherein the set of operations is controlled based on the generated value tree.
